(19) United States
(12) Patent Application Publication
(10) Pub. No.: US 2024/0365813 A1
(43) Pub. Date: Nov. 7, 2024

(54) HIGH PROTEIN SNACK COMPOSITIONS

(71) Applicant: Rally Inc., Sonoma, CA (US)

(72) Inventors: John Thamm, Lancaster, SC (US); Ralph Jerome, New Hope, PA (US)

(21) Appl. No.: 18/635,814

(22) Filed: Apr. 15, 2024

Related U.S. Application Data
(60) Provisional application No. 63/496,382, filed on Apr. 14, 2023.

(51) Int. Cl. A23J 3/26; A23D 9/007; A23D 9/04; A23J 3/14; A23L 7/10; A23L 11/00; A23L 27/40; A23P 20/10; A23P 20/25; A23P 30/25

(52) U.S. Cl. CPC A23J 3/26; A23D 9/007; A23D 9/04; A23J 3/14; A23L 7/198; A23L 11/05; A23L 27/40; A23P 20/10; A23P 20/25; A23P 30/25

(57) ABSTRACT

Nutritious and delicious high protein and fiber, low starch snack compositions and methods of preparing the snack compositions are described including soft spread compositions, extruded snack compositions, and dual-texture co-extruded snack compositions.

### 1. BACKGROUND OF THE INVENTION

Dual-texture products typically have a harder outer shell portion and a softer inner filling portion. Such products have application in both human foods and animal food products. The dual-texture nature of these products provides several advantages over single-texture products including consumer preference and increased product variety. While dual-texture is one option for presenting such products, the products can also be presented as single texture, such as a harder shell product or a spreadable product.

Cooker extrusion technology is utilized worldwide to produce a range of expanded foods that permeate our lives, culminating in a trillion-dollar industry.

Cooker extrusion with starch-based foods is well-documented and provides a wide variety of ready-to-eat cereals and snacks. Extrusion cooking may be employed to achieve high production rates and desirable product attributes such as low bulk densities, uniform cell structure, crisp or crunchy textures. Product formulation for extrusion technology is built on the gelatinization and physical properties of starch. Starch is inexpensive and functional but perceived as unhealthy. High glycemic foods, whether from starch or sugars, have a significantly negative impact on the metabolic health.

Cooker extrusion with high protein/low starch material is more difficult as proteins tend to inhibit expansion due to their inherent nature to denature and texturize during extrusion processes (Ganjyal, G., N. Reddy, Y. Yang, and M. Hanna. 2004. Biodegradable Packaging Foams of Starch Acetate Blended with Corn Stalk Fibers. Journal of Applied Polymer Science 93 (6): 2627-2633). Others have disclosed undesirable absorption characteristics, textural characteristics, and color in whey protein crisps having high levels of whey protein.

There is a need to provide nutritious snack food products, particularly dual-texture extruded snack food products, having optimal nutritional properties, good organoleptic properties (i.e., desirable flavor, clean finish, low mouth viscosity, minimal or absent aftertaste), and desirable functional properties (i.e., stable shelf-life).

### 2. SUMMARY OF THE INVENTION

The present disclosure provides a nutritious, plant-based, high protein, low starch snack foods and improved methods of making the same.

In a first aspect of the present disclosure, a soft spread composition comprising a plant-based protein component and a lipid component is provided, wherein the plant-based protein component comprises at least one pulse protein source, and the lipid component comprises at least one fat and at least one oil.

In a second aspect of the present disclosure, a method of preparing a soft spread composition is provided comprising: (a) cooker extruding a dry mixture of (i) a plant-based protein component comprising at least one pulse protein source and (ii) water to provide an extruded spread pre-mixture; (b) drying the extruded spread pre-mixture to provide a dried spread pre-mixture, (c) milling the dried spread pre-mixture, (d) combining the dried spread pre-mixture with a lipid component comprising at least one fat and at least one oil and one or more additives to provide a wet spread mixture, and (e) subjecting the wet spread mixture to high shear mixing until the resulting material is substantially homogenous and creamy, thereby providing a soft spread composition.

In a third aspect of the present disclosure, an extruded high protein snack composition is provided comprising a plant-based protein component comprising at least one pulse protein source.

In a fourth aspect of the present disclosure, a method of preparing a plurality of high protein snack compositions is provided comprising: (a) mixing a dry mixture of a plant-based protein component comprising at least one pulse protein source and optionally one or more additives with water to provide a dough; (b) cooker extruding the dough to provide a continuous extrudate; (c) cutting the continuous extrudate to form a plurality of high protein snack compositions; (d) drying the plurality of high protein snack compositions; (e) optionally, coating the high protein snack compositions with a topical seasoning comprising at least one oil and at least one dry seasoning; and (f) optionally, packaging the high protein snack compositions.

In a fifth aspect of the present disclosure, a dual-texture high protein extruded composition is provided comprising: (a) a soft spread composition comprising a first plant-based protein component and a lipid component, wherein the plant-based protein component comprises at least one pulse protein source and the lipid component comprises at least one fat and at least one oil; and (b) a crunchy shell composition in direct contact with the soft spread composition, wherein the crunchy shell composition comprises a second plant-based protein component comprising at least one pulse protein source.

In a sixth aspect of the present disclosure, a method of making a plurality of dual-texture high protein extruded compositions is provided comprising: (a) preparing a soft spread composition comprising: (i) cooker extruding a dry mixture comprising a first plant-protein component comprising at least one pulse protein source and water to provide an extruded spread pre-mixture; (ii) drying the extruded spread pre-mixture to provide a dried spread pre-mixture; (iii) milling the dried spread pre-mixture; (iv) combining the milled, dried spread pre-mixture with a lipid component comprising at least one fat and at least one oil and optionally, one or more additives to provide a wet spread mixture, and (v) subjecting the wet spread mixture to high shear mixing until the resulting material is substantially homogenous and creamy, thereby providing the soft spread composition; (b) preparing a shell dough composition comprising: (i) mixing a dry mixture of a second plant-based protein component comprising at least one pulse protein source, and water to form a shell dough; (c) co-extruding the shell dough composition into a continuous hollow tube shape and pumping the soft spread composition into the void of the tube shape to provide a crispy, continuously filled tube; (d) crimping the continuous filled tube to provide a plurality of dual-texture high protein extruded compositions; (e) drying the plurality of dual-texture high protein extruded compositions; and (f) optionally, coating the dual-texture high protein extruded compositions with a topical seasoning comprising at least one oil and at least one dry seasoning.

### 3. BRIEF DESCRIPTION OF THE SEVERAL VIEWS OF THE DRAWINGS

These and other features, aspects, and advantages of the present invention will become better understood with regard to the following description, and accompanying drawings, where:

FIG. 1 depicts a block diagram representation of a method of preparing the dual-texture high protein extruded composition.

FIG. 2 depicts an exemplary high protein snack composition.

FIG. 3 depicts an exemplary plurality of dual-texture high protein extruded compositions.

### 4. DETAILED DESCRIPTION OF THE INVENTION

### 4.1. Definitions

The term “extrusion,” as used herein, generally refers to the process of processing the protein mixture using either a single-screw or twin-screw extruder. Extrusion creates objects of a fixed cross-sectional profile. A material is pushed or pulled through a die of the desired cross-section. High-moisture extrusion is known as wet extrusion. Extruders typically comprise an extruder barrel within which rotates a close-fitting screw. The screw is made up of screw elements, some of which are helical screw threads to move material through the extruder barrel. Material is introduced into the extruder barrel toward one end, moved along the extruder barrel by the action of the screw and is forced out of the extruder barrel through a nozzle or die at the other end. The rotating screw mixes and works the material in the barrel and compresses it to force it through the die or nozzle. The degree of mixing and work to which the material is subjected, the speed of movement of the material through the extruder barrel and thus the residence time in the extruder barrel and the pressure developed in the extruder barrel can be controlled by the pitch of the screw thread elements, the speed of rotation of the screw and the rate of introduction of material into the extruder barrel. The extruder barrel comprises multiple extruder barrel sections which are joined end to end. Multiple extruder barrel sections are required to carry out different processes involved in extrusion such as conveying, kneading, mixing, devolatilizing, metering and the like. Each extruder barrel section comprises a liner which is press fit into an extruder barrel casing, and heating and cooling elements are provided to regulate temperature of extruder barrel section within permissible range. The total length of an extrusion process can be defined by its modular extrusion barrel length. An extruder barrel is described by its unit of diameter. A “cooling die” cools the extruded product to a desired temperature. Hot extrusion is used to thermomechanically transform raw materials in short time and high temperature conditions under pressure.

Steam-induced expansion involves melt expansion at the die exit due to water flashing off, hence leading to highly expanded products. Subsequent processing then determines the textural attributes of extruded products such as crispness, crunchiness, hardness, etc. Heat can be applied either through, for example, steam injection, external heating of the barrel, or mechanical energy. The material can be pumped, shaped and expanded, which forms the porous and fibrous texture, and partially dehydrates the product. The shape and size of the final product can be varied by using different die configurations. Extruders can be used to make products with little expansion (such as pasta), moderate expansion (shaped breakfast cereal, meat substitutes, breading substitutes, modified starches, pet foods (soft, moist and dry), or a great deal of expansion (puffed snacks, puffed curls and balls, etc.).

In some extruders, the material may be extruded by means of a ram or a piston. Other extruders use one or more screws. Variable pitch single screw extruders produce high product consistency by combining the ingredients to produce a homogeneous mixture and pushing it out of the machine at a rate that is highly controllable. Twin screw extruders contain two screws that are either co-current (the screws rotate in the same direction) or are counter-current (the screws rotate in opposite directions). Twin screw extruders can handle material with a wide range of moisture content and have greater control over the residence time and the amount of shear to which the material is exposed.

The ingredients may be fed into the extruder via a feeder, such as, but not limited to, a gravimetric or volumetric feeder. The type of feeder used depends on the type of ingredient, and different feeders are used for batch versus continuous feed. The feeder also can direct the ingredients into a preconditioner, if desired. The feed section of the screw may have deep flights to accept the ingredients and move the ingredients forward. The ingredients move into the compression section of the screw, which is heated, and has either shallower or more frequent flights, which compresses the ingredients and works them into continuous dough. The cooking section of the screw applies maximum heat, pressure and shear to the mixture in the barrel prior to the die. Within the screw barrel, the mixture is heated and pressurized. When the mixture emerges through the die, the reduction in pressure to atmospheric pressure generally causes the mixture to expand. If the moist dough within the barrel is heated over 100° C., the sudden reduction in pressure to atmospheric pressure causes the moisture to convert to steam. The combination of sudden expansion and associated cooling yields a puffed, crisp product.

One exemplary extrusion device is a double-barrel, twin screw extruder as described, for example, in U.S. Pat. No. 4,600,311. Examples of commercially available double-barrel, twin screw extrusion apparatus include a CLEXTRAL® Model BC-72 extruder manufactured by Clextral, Inc. (Tampa, Fla.): a WENGER R: Model TX-57 extruder manufactured by Wenger (Sabetha, Kans.); and a WENGER: R: Model TX-52 extruder manufactured by Wenger (Sabetha, Kans.). Other extruders are described, for example, in U.S. Pat. Nos. 4,763,569, 4,118,164, and 3,117,006, which are hereby incorporated by reference herein.

The screws of a twin-screw extruder can rotate within the barrel in the same (co-rotating) or opposite directions (counter-rotating). Rotation of the screws in the same direction is referred to as single flow whereas rotation of the screws in opposite directions is referred to as double flow (counter-rotating). Typically, co-rotating twin screw extruders are used in the manufacturing of puffed snack products. The speed of the screw or screws of the extruder may vary depending on the particular apparatus. However, the screw speed is typically from about 200 to about 600 revolutions per minute (rpm). Generally, as the screw speed increases, the density of the extrudates decreases. Particularly, the screw speed of the twin screw extruder may effect residence time of the dough in the extruder, the amount of shear generated, and the degree of cooking of the dough: as the screw speed increases, residence time decreases, and the amount of shear increases.

Among other things, conventional extruder systems generally act as an ingredient mixer (e.g., to form the dough), mixture cooker, and composition (extrudate) former. Each of these functions can be accomplished in the same cooking extruder. In some instances, however, it may be desirable to have at least two extruders arranged in a series. The extrusion apparatus also can include one or more heating zones through which the dough is conveyed under mechanical pressure prior to exiting the extrusion apparatus through an extrusion die. Typically, the extrusion mass is subjected to a pressure of at least about 400 psi (about 28 bar). The barrel pressure is dependent on numerous factors including, for example, the extruder screw speed, feed rate of the mixture to the barrel, feed rate of water to the barrel, and the viscosity of the dough within the barrel. Water can also be injected into the extruder barrel to further hydrate the dough. As an aid in forming the dough, the water may also act as a plasticizing agent. Water may be introduced to the extruder barrel via one or more injection jets in communication with a heating zone. Typically, water is injected at a rate of from about 2 kg/hr to about 7 kg/hr. The mixture in the barrel typically contains from about 15% to about 30% (by weight) water. The rate of introduction of water to any of the heating zones is generally controlled to promote production of an extrudate having desired characteristics. It has been observed that as the rate of introduction of water to the barrel decreases, the density of the extrudate decreases. The dough in the extrusion apparatus is extruded through a die to produce an extrudate.

In an embodiment, high moisture extrusion e.g., extrusion at higher moisture contents (>40%), also known as wet extrusion, can be used to create a fresh (non-dried) product. Generally, wet extrusion applications utilize twin screw extruders due to their efficient conveying capabilities.

Upon release of pressure, dough-like material exits the extruder barrel through the die, superheated water present in the mass flashes off as steam, causing simultaneous expansion (i.e., puffing) of the material. The level of expansion of the extrudate upon exiting of the mixture from the extruder in terms of the ratio of the cross-sectional area of extrudate to the cross-sectional area of die openings is generally less than about 50:1. Typically, the ratio of the cross-sectional area of extrudate to the cross-sectional area of die openings is from about 2:1 to about 50:1.

The term “lipid” refers to all edible, fatty acid triglycerides regardless of origin or whether they are solid or liquid at room temperature.

The term “hard fat” or “hydrogenated fat” refers to a fat which is a solid at room temperature (i.e. 23° C.), preferably with a melting point of at least 25° C.

The term “oil” refers to those fats which are liquid in their unmodified state. Natural and synthetic fats and oils are included in these terms.

The term “soft fat” refers to a fat which is semi-solid at room temperature (i.e., 23° C.).

The term “soft spread” or “spread” refers to food products that contain less than 10 wt % water and characterized by a texture that renders the product spreadable, e.g., with a knife on a substrate such as a cracker or slice of bread.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

### 4.2. Soft Spread Compositions

In one aspect, soft spread compositions are provided. It is common for soft spread compositions, e.g., those found within dual-texture snacks, to have a dry, claggy eating experience. In contrast, the soft spread compositions of the present disclosure excite salivation while delivering a desirable flavor, clean finish (low mouth viscosity) and aftertaste. Additionally, the soft spread composition serves as a carrier of one or more additives, e.g., vitamins, flavors, colors, antioxidants, omega fatty acids, prebiotics, and probiotics. The soft spread composition of the present disclosure delivers a micronutrient fortified, low water activity substrate that retains integrity and efficacy throughout an extended shelf life.

Particle size distribution (PSD), particle shape and fat absorption as a function of ingredient types and dosing levels minimize lipid content, enabling improved nutrition, processing capability (pumpable viscosity) and a consumer preferred mouthfeel and clearing.

In some embodiments, the soft spread composition can be characterized by one or more of cook (i.e., glass transition temperature), particle size, and viscosity.

In some embodiments, the soft spread composition has a glass transition temperature (Tg) from 100° C. to 160° C., e.g., from 100° C. to 140° C., from 100° C. to 120° C., from 120° C. to 160° C., from 120° C. to 140° C., or from 140° C. to 160° C.

In some embodiments, the soft spread composition has a particle size distribution of from about 50 microns to about 800 microns, such as, for example, from about 50 microns to about 500 microns, from about 50 microns to about 400 microns, from about 50 microns to about 250 microns, from about 100 microns to about 800 microns, from about 100 microns to about 500 microns, from about 100 microns to about 250 microns, from about 200 microns to about 800 microns, from about 200 microns to about 500 microns, from about 200 microns to about 400 microns, from about 300 microns to about 800 microns, from about 300 microns to about 500 microns, from about 400 microns to about 800 microns, from about 400 microns to about 500 microns, or from about 400 microns to about 800 microns.

In some embodiments, the soft spread composition has a viscosity less than about 500,000 CPS at ambient temperature (e.g., 75 F), e.g., less than about 400,000 CPS, less than about 300,000 CPS, less than about 200,000 CPS, or less than about 100,000 CPS. In some embodiments, the soft spread composition has a viscosity from about 250,000 CPS to about 500,000 CPS at ambient temperature (e.g., 75 F), e.g., from 250,000 CPS to 450,000 CPS, from 250,000 CPS to 400,000 CPS, from 250,000 CPS to 350,000 CPS, from 250,000 CPS to 300,000 CPS, from 300,000 CPS to 500,000 CPS, from 300,000 CPS to 450,000 CPS, from 300,000 CPS to 400,000 CPS, from 300,000 CPS to 350,000 CPS, from 350,000 CPS to 500,000 CPS, from 350,000 CPS to 450,000 CPS, from 350,000 CPS to 400,000 CPS, from 400,000 CPS to 500,000 CPS, from 400,000 CPS to 450,000 CPS, or from 450,000 CPS to 500,000 CPS.

The soft spread composition spreads like a soft cream, similar to a nut butter or chocolate spread. The soft spread composition has a hardness (T) maximum of about 1000 g, as products with a higher hardness are not spreadable at room temperature. In some embodiments, the soft spread composition has a maximum hardness (T) of about 800 g. a maximum hardness (T) of about 600 g, or a maximum hardness (T) of about 500 g. In some embodiments, the hardness (T) of the soft spread composition is at least about 25 g, e.g., at least about 35 g. This results in a composition which is not too liquid or too hard. The former risks leaking through the substrate while the latter are not well spreadable.

In certain embodiments, the soft spread composition has a hardness (T) from about 25 g to about 1,000 g, e.g., from about 25 g to about 900 g, from about 25 g to about 800 g, from about 25 g to about 600 g, from about 25 g to about 500 g, from about 25 g to about 400 g, from about 25 g to about 300 g, from about 25 g to about 200 g, from about 25 g to about 100 g, from about 50 g to about 1,000 g, from about 50 g to about 900 g, from about 50 g to about 800 g, from about 50 g to about 700 g, from about 50 g to about 600 g, from about 50 g to about 500 g, from about 50 g to about 400 g, from about 50 g to about 300 g, from about 50 g to about 200 g, from about 50 g to about 100 g, from about 100 g to about 1,000 g, from about 100 g to about 900 g, from about 100 g to about 800 g, from about 100 g to about 700 g, from about 100 g to about 600 g, from about 100 g to about 500 g, from about 100 g to about 400 g, from about 100 g to about 300 g, from about 100 g to about 200 g, from about 200 g to about 1,000 g, from about 200 g to about 800 g, from about 200 g to about 600 g, from about 200 g to about 500 g, from about 300 g to about 1,000 g, from about 300 g to about 800 g, from about 300 g to about 600 g, from about 300 g to about 500 g, from about 400 g to about 1,000 g, from about 400 g to about 800 g, from about 400 g to about 600 g, from about 400 g to about 500 g, from about 500 g to about 1,000 g, from about 500 g to about 800 g, from about 500 g to about 600 g, from about 600 g to about 1,000 g, from about 600 g to about 800 g, from about 700 g to about 1,000 g, from about 800 g to about 1,000 g, or from about 900 g to about 1,000 g.

The hardness (T) of the soft spread composition is expressed in grams and can be measured, e.g., with an SMS-Texture Analyzer at 20° C. using a metal or hard plastic cylindrical probe of a diameter of 10 mm, to a penetration depth of 10 mm at a probe speed of 0.5 mm/sec.

In some embodiments, the soft spread composition comprises water in an amount of, at most, about 10 wt %, such as, for example, about 8 wt % or less, about 7 wt % or less, about 6 wt % or less, about 5 wt % or less, about 4 wt % or less, about 3 wt % or less, about 2 wt % or less, or about 1 wt % or less.

In some embodiments, the soft spread composition has a low water activity (aw). The water activity of a food is the ratio between the vapor pressure of the food itself, when in a completely undisturbed balance with the surrounding air media, and the vapor pressure of distilled water under identical conditions. A water activity of 0.80 means the vapor pressure is 80 percent of that of pure water. The water activity increases with temperature. The moisture condition of a product can be measured as the equilibrium relative humidity (ERH) expressed in percentage or as the water activity expressed as a decimal. Most foods have a water activity above 0.95 and that will provide sufficient moisture to support the growth of bacteria, yeasts, and mold.

In some embodiments, the soft spread composition has an aw of about 0.30 or less, such as, for example, about 0.25 or less, about 0.20 or less, about 0.15 or less, about 0.10 or less, or about 0.05 or less.

In some embodiments, the soft spread composition has an aw from about 0.05 to about 0.30, e.g., from about 0.05 to about 0.25, from about 0.05 to about 0.20, from about 0.05 to about 0.1, from about 0.05 to about 0.1, from about 0.1 to about 0.30, from about 0.1 to about 0.25, from about 0.1 to about 0.20, from about 0.1 to about 0.15, from about 0.15 to about 0.30, from about 0.15 to about 0.25, from about 0.15 to about 0.20, from about 0.20 to about 0.30, from about 0.20 to about 0.25, or from about 0.25 to about 0.30. In some embodiments, the soft spread composition has a stable shelf-life of at least about 6 months, at least about 7 months, at least about 8 months, at least about 9 months, at least about 10 months, at least about 11 months, or at least about 12 months. Shelf-life stability can be measured according to methods known in the art, e.g., HPLC, visual inspection, and chemical analysis over time. “Stable” refers to not more than 5% change (e.g., degradation, transformation) in a given ingredient and no visible change from the initial form of the soft spread composition (e.g., transitions to un-spreadable, settling out of oil, etc.).

In some embodiments, the soft spread composition has one or more of: a particle size from less than about 800 microns, a viscosity less than about 500,000, an aw of about 0.30 or less, and a stable shelf-life of at least about 12 months. In some embodiments, the soft spread composition has one or more of: a particle size from about 50 microns to about 800 microns, a viscosity from about 250,000 CPS to about 500,000 CPS, an aw from about 0.05 to about 0.30, and a stable shelf-life of at least about 12 months.

The soft spread composition exhibits one or more desirable nutritional properties: low glycemic index, high protein quality, glycemic neutrality, low calorie content, excellent source of protein and fiber, low net carbs, low starch, and low fat.

In some embodiments, the soft spread composition has a protein content of about 5 g to about 15 g per 1 oz (33 g) serving, such as, for example, from about 5 g to about 10 g or about 10 g to about 15 g.

In some embodiments, the soft spread composition has a fat content of about 5 g to about 15 per 1 oz (33 g) serving, such as, for example, from about 5 g to about 10 g or about 10 g to about 15 g.

In some embodiments, the soft spread composition has a calorie content of 350 calories or less per 1 oz. serving (33 g), e.g., from about 50 to about 350 calories, from about 50 to about 250 calories, from about 50 to about 200 calories, from about 50 to about 150 calories, from about 50 to about 100 calories, from about 100 to about 350 calories, from about 100 to about 300 calories, from about 100 to about 250 calories, from about 100 to about 200 calories, from about 100 to about 150 calories, from about 150 to about 350 calories, from about 150 to about 300 calories, from about 150 to about 250 calories, from about 150 to about 200 calories, from about 200 to about 350 calories, from about 200 to about 300 calories, from about 200 to about 250 calories, from about 250 to about 350 calories, from about 250 to about 300 calories, or from about 300 to about 350 calories. In some embodiments, the soft spread composition has a calorie content of about 150 to about 250 calories per 1 oz (33 g) serving, such as, for example, from about 150 to about 200 calories or from about 200 to about 250 calories. In some embodiments, the soft spread composition has a total starch content of about 5 g to about 15 g per 1 oz (28 g) serving, such as, for example, from about 5 g to about 10 g, or from about 10 g to about 15 g.

In some embodiments, the soft spread composition has a total fiber content of about 3 g to about 10 g, such as, for example, from about 3 g to about 8 g, from about 3 g to about 5 g, or from about 5 g to about 10 g.

The attributes above enable improved nutrition, processing capability (pumping viscosity), and consumer preferred mouthfeeling and clearing.

In some embodiments, the soft spread composition is provided in a container, e.g., a single-use or resealable glass container (e.g., a jar), a single-use or resealable plastic container pouch, a single-use pouch (e.g. a squeeze pouch), a resealable pouch, etc.

In some embodiments, the soft spread composition is encased within an extruded high protein snack composition, as described hereinbelow.

### 4.2.1. Plant-Based Protein

The soft spread compositions comprise a plant-based protein component. The plant-based protein can be provided in various formats, such as a concentrate, an isolate, a hydrolysate, a flour, or a meal. The type of protein will be selected based on various criteria, such as the protein content in the ingredient and suitability for extrusion processing.

In some embodiments, the plant-based protein component comprises at least one pulse protein source. In some embodiments, the plant-based protein component consists of at least one pulse protein source. Exemplary pulses that function as protein sources include, but are not limited to, pea, pinto bean, navy bean, black bean, and lentil.

In some embodiments, the soft spread composition contains pea protein, e.g., yellow pea protein. Both intact and hydrolyzed pea protein sources can be used. Particularly suitable pea proteins include pea proteins derived from Pisum sativum. Pea proteins derived from other species of peas, including green peas and field peas, can also be used.

Pea protein is commercially available in the form of pea protein concentrates (PPC) and pea protein isolates (PPI). PPC contain from about 60 to 90 wt. % pea protein. Meanwhile, PPI contains from about 80 to 90 wt. % pea protein. These PPCs and PPIs typically exhibit one or more of the following attributes: (1) poured bulk density, as measured by gravimetry, of about 0.4 Kg/L; (2) a pH in a 10% solution of water of about 7; (3) a residue on a 70 mesh screen as measured by sieving of a maximum of 10% by weight; (4) a carbohydrate concentration of about 3 grams per 100 grams of intact pea protein; (5) a fat concentration of about 6 grams per 100 grams of intact pea protein; and/or (6) an ash concentration of about 4 grams per 100 grams of intact pea protein.

One exemplary pea protein concentrate is NUTRALYS® F85F pea protein isolate (about 83% by weight intact pea protein), available from Roquette Freres, Lestrem France.

In some embodiments, the protein source is a pulse flour. In some embodiments, the protein source is a pea flour. In some embodiments, the protein source is a pulse meal. In some embodiments, the protein source is a pea meal.

For example, a yellow pea meal contains, per 100 grams 23 g protein and about 20 g fiber.

In some embodiments, the plant-based protein component further comprises at least one rice protein. The rice protein can be provided in various formats, such as rice protein (enzymatically prepared by methods known in the art), a flour, or a meal. Suitable rice protein sources include, but are not limited to, brown rice, white rice, wild rice, black rice, and red rice. Rice proteins derived from Asian rice (Oryza sativa) and African rice (Oryza glabemma) can be used.

As is well-known, brown rice, which is sometimes referred to as “hulled” or “unmilled” rice, is whole grain rice, i.e., rice in which the hull has been removed but the bran and the germ have not. In contrast, white rice is rice in which the hull, bran and germ have all been removed.

Brown rice protein is commercially available in the form of brown rice protein concentrates and isolates. These sources are available from a wide variety of different manufacturers including Nutribiotic, Jarrow Formulas, Vitacost, Sunwarrier, and Axiom Foods and AIDP (sprouted brown rice). In one example, a rice protein has about 80% protein, about 8% dietary fiber, about 19% carbohydrates, about 2.25% ash, and about 5% fat.

In some embodiments, the plant-based protein component further comprises fiber. In some embodiments, the fiber is included in the protein source, e.g., the pea protein flour contains pea fiber as well. In other embodiments, the fiber source (e.g., pea fiber) is added as a separate ingredient. Exemplary fiber sources include, but are not limited to, pea, pinto bean, navy bean, black bean, and lentil.

In some embodiments, the plant-based protein component comprises at least one pulse protein source and at least one rice protein source. In some embodiments, the plant-based protein component comprises at least one pulse protein source, at least one rice protein source, and at least one fiber source. In exemplary embodiments, the plant-based protein component comprises yellow pea flour, pea protein isolate, pea fiber, and brown rice protein.

In some embodiments, the soft spread composition comprises from about 50 wt % to about 80 wt % plant-based protein component, such as, for example, from about 50 wt % about 70 wt %, from about 50 wt % to about 60 wt %, from about 60 wt % to about 80 wt %, from about 60 wt % to about 70 wt %, or from about 70 wt % to about 80 wt %. In some embodiments, the soft spread composition comprises from about 50 wt % to about 60 wt %, from about 50 wt % to about 55 wt %, or from about 55 wt % to about 60 wt %. plant-based protein component.

In some embodiments, the plant-based protein component comprises from about 60 wt % to about 99 wt % at least one protein source and from about 1 wt % to about 40 wt % at least one fiber source. In some embodiments, the plant-based protein component comprises from about 75 wt % to about 99 wt % at least one protein source and from about 1 wt % to about 25 wt % at least one fiber source. In some embodiments, the plant-based protein component comprises from about 80 wt % to about 99 wt % at least one protein source and from 1 wt % to about 20 wt % at least one fiber source. In some embodiments, the plant-based protein component comprises from about 85 wt % to about 95 wt % at least one protein source and from about 15 wt % to about 5% of at least one fiber source. In some embodiments, the plant-based protein component comprises from about 90 wt % to about 95 wt % at least one protein source and 10 wt % to about 5 wt % at least one fiber source.

In some embodiments, the plant-based protein component comprises from about 20 wt % to about 80 wt % of at least one pulse flour (e.g., pea flour), such as, for example, from about 20 wt % to about 50 wt %, from about 30 wt % to about 80 wt %, from about 30 wt % to about 50 wt %, from about 40 wt % to about 80 wt %, from about 40 wt % to about 50 wt %, and from about 50 wt % to about 80 wt %. In some embodiments, the plant-based protein component comprises from about 30 wt % to about 50 wt % at least one pulse flour, such as, for example, from about 30 wt % to about 40 wt %, or from about 40 wt % to about 50 wt %.

In some embodiments, the plant-based protein component comprises from about 10 wt % to about 20 wt % at least one rice protein (e.g., brown rice protein), such as, for example, from about 10 wt % to about 15 wt % or about 15 wt % to about 20 wt %.

In some embodiments, the plant-based protein component comprises from about 20 wt % to about 40 wt % at least one pulse protein (e.g., pea protein isolate), such as, for example, from about 20 wt % to about 25 wt % or from about 25 wt % to about 30 wt %.

In some embodiments, the plant-based protein component comprises from about 1 wt % to about 40 wt % at least one pulse fiber (e.g., pea fiber), such as, for example, from about 1 wt % to about 30 wt %, from about 1 wt % to about 20 wt %, from about 10 wt % to about 40 wt %, from about 10 wt % to about 30 wt %, from about 10 wt % to about 20 wt %, from about 20 wt % to about 40 wt %, from about 20 wt % to about 30 wt %, or from about 30 wt % to about 40 wt %. In some embodiments, the plant-based protein component comprises from about 10 wt % to about 15 wt %, or from about 15 wt % to about 20 wt %, at least one pulse fiber.

### 4.2.2. Lipid

The soft spread compositions comprise a lipid component comprising at least one fat and at least one oil.

In some embodiments, any fat or source thereof that is suitable for use in edible food products can be used. In some embodiments, the fat can be a hard fat. In other embodiments, the fat can be a soft fat. In some embodiments, the fat used herein comprises fully or partially hydrogenated oil(s), solid stearin fractions, partial esters such as diglycerides and monoglycerides, and waxes or mixtures thereof.

In some embodiments, the soft spread composition comprises from about 15 wt % to about 30 wt % at least one fat, such as, for example, from about 15 wt % to about 25 wt %, from about 15 wt % to about 20 wt %, from about 20 wt % to about 30 wt %, from about 20 wt % to about 25 wt %, or from about 25 wt % to about 30 wt %.

In some embodiments, the oil is a vegetable oil. In some embodiments, the oil is selected from rapeseed oil, corn oil, soybean oil, sunflower seed oil, cotton seed oil, maize oil, olive oil, hazelnut oil, groundnut oil, or liquid fractions of palm oil or of shea butter. This includes varieties of these liquid oils, such as high oleic sunflower oil and high oleic rapeseed oil. In some embodiments, the oil comprises high oleic sunflower oil.

In some embodiments, the soft spread composition comprises from about 5 wt % to about 20 wt % at least one oil, such as, for example, from about 5 wt % to about 15%, from about 5 wt % to about 10 wt %, from about 10 wt % to about 20 wt %, from about 10 wt % to about 15 wt %, or from about 15 wt % to about 20 wt %.

In some embodiments, the soft spread composition comprises from about 20 wt % to about 50 wt % lipid component, such as, for example, from about 20 wt % to about 40 wt %, from about 20 wt % to about 30 wt %, from about 30 wt % to about 50 wt %, from about 30 wt % to about 40 wt %, or from about 40 wt % to about 50 wt %.

In some embodiments, the soft spread composition comprises from about 35 wt % to about 40 wt % lipid component, such as, for example, from about 36 wt % to about 40 wt %, from about 37 wt % to about 40 wt %, from about 38 wt % to about 40 wt %, or from about 39 wt % to about 40 wt %.

### 4.2.3. Additives

In certain embodiments, the soft spread composition further comprises one or more additives. Common additives that can be added include, but are not limited to stabilizers, flavoring agents, emulsifiers, anti-spattering agents, colorants, or antioxidants. Exemplary additives are described, for example, in Campbell et al., Food Fats and Oils, 8th Ed., Institute of Shortening and Edible Oils, Washington, D.C.

In certain embodiments, the soft spread composition further comprises a preservative or an antioxidant. A wide variety of preservatives and antioxidants are suitable for use, including but not limited to butylated hydroxytoluene (BHT), butylated hydroxyanisole (BHA), tertiary butylhydroquinone (TBHQ), ethylenediaminetetracetic acid (EDTA), gallate esters (i.e. propyl gallate, butyl gallate, octyl gallate, dodecyl gallate, etc.), tocopherols, lactic acid, citric acid, citric acid esters (i.e. isopropyl citrate, etc.), gum guaiac, nordihydroguaiaretic acid (NDGA), thiodipropionic acid, ascorbic acid, ascorbic acid esters (i.e. ascorbyl palmitate, ascorbyl oleate, ascorbyl stearate, etc.) tartaric acid, lecithin, methyl silicone, sodium benzoate, polymeric antioxidant (Anoxomer) plant (or spice and herb) extracts (i.e. rosemary, sage, oregano, thyme, marjoram, etc.) and mixtures thereof.

In some embodiments, the soft spread composition further comprises at least one emulsifier. Emulsifying agents may be phospholipids and proteins or esters of long chain fatty acids and a polyhydric alcohol. Lecithin is an example. Fatty acid esters of glycerol, polyglycerol esters of fatty acids, sorbitan esters of fatty acids and polyoxyethylene and polyoxypropylene esters of fatty acids and mixtures thereof may be used.

In some embodiments, the soft spread composition further comprises one or more functional ingredients. Exemplary functional ingredients include, but are not limited to, antioxidants, vitamins, minerals, probiotics, fatty acids, phytosterol, or phytostanols. In such embodiments, the soft spread composition functions as a carrier or delivery system for the functional ingredients.

Generally, the at least one functional ingredient is present in the composition in an amount sufficient to promote health and wellness.

Vitamins are organic compounds that the human body needs in small quantities for normal functioning. The body uses vitamins without breaking them down, unlike other nutrients such as carbohydrates and proteins. To date, thirteen vitamins have been recognized, and one or more can be used in the compositions herein. Suitable vitamins include, vitamin A, vitamin D, vitamin E, vitamin K, vitamin B1, vitamin B2, vitamin B3, vitamin B5, vitamin B6, vitamin B7, vitamin B9, vitamin B12, and vitamin C.

Various other compounds have been classified as vitamins by some authorities. These compounds may be termed pseudo-vitamins and include, but are not limited to, compounds such as ubiquinone (coenzyme Q10), pangamic acid, dimethylglycine, taestrile, amygdaline, flavanoids, para-aminobenzoic acid, adenine, adenylic acid, and s-methylmethionine. As used herein, the term vitamin includes pseudo-vitamins.

Examples of suitable antioxidants include, but are not limited to, vitamins, vitamin cofactors, minerals, hormones, carotenoids, carotenoid terpenoids, non-carotenoid terpenoids, flavonoids, flavonoid polyphenolics (e.g., bioflavonoids), flavonols, flavones, phenols, polyphenols, esters of phenols, esters of polyphenols, nonflavonoid phenolics, isothiocyanates, and combinations thereof. In some embodiments, the antioxidant is vitamin A, vitamin C, vitamin E, ubiquinone, mineral selenium, manganese, melatonin, a-carotene, 3 carotene, lycopene, lutein, zeanthin, crypoxanthin, reservatol, eugenol, quercetin, catechin, gossypol, hesperetin, curcumin, ferulic acid, thymol, hydroxytyrosol, tumeric, thyme, olive oil, lipoic acid, glutathinone, gutamine, oxalic acid, tocopherol-derived compounds, butylated hydroxyanisole (BHA), butylated hydroxytoluene (BHT), ethylenediaminetetraacetic acid (EDTA), tert-butylhydroquinone, acetic acid, pectin, tocotrienol, tocopherol, coenzyme QIO, zeaxanthin, astaxanthin, canthaxantin, saponins, limonoids, kaempfedrol, myricetin, isorhamnetin, proanthocyanidins, quercetin, rutin, luteolin, apigenin, tangeritin, hesperetin, naringenin, erodictyol, flavan-3-ols (e.g., anthocyanidins), gallocatechins, epicatechin and its gallate forms, epigallocatechin and its gallate forms (ECGC) theaflavin and its gallate forms, thearubigins, isoflavone, phytoestrogens, genistein, daidzein, glycitein, anythocyanins, cyaniding, delphinidin, malvidin, pelargonidin, peonidin, petunidin, ellagic acid, gallic acid, salicylic acid, rosmarinic acid, cinnamic acid and its derivatives (e.g., ferulic acid), chlorogenic acid, chicoric acid, gallotannins, ellagitannins, anthoxanthins, betacyanins and other plant pigments, silymarin, citric acid, lignan, antinutrients, bilirubin, uric acid, R-a-lipoic acid, N acetylcysteine, emblicanin, apple extract, apple skin extract (applephenon), rooibos extract red, rooibos extract, green, hawthorn berry extract, red raspberry extract, green coffee antioxidant (GCA), aronia extract 20%, grape seed extract (VinOseed), cocoa extract, hops extract, mangosteen extract, mangosteen hull extract, cranberry extract, pomegranate extract, pomegranate hull extract, pomegranate seed extract, hawthorn berry extract, pomella pomegranate extract, cinnamon bark extract, grape skin extract, bilberry extract, pine bark extract, pycnogenol, elderberry extract, mulberry root extract, wolfberry (gogi) extract, blackberry extract, blueberry extract, blueberry leaf extract, raspberry extract, turmeric extract, citrus bioflavonoids, black currant, ginger, acai powder, green coffee bean extract, green tea extract, and phytic acid, or combinations thereof. In alternate embodiments, the antioxidant is a synthetic antioxidant such as butylated hydroxytolune or butylated hydroxyanisole, for example.

Minerals comprise inorganic chemical elements required by living organisms. Minerals are comprised of a broad range of compositions (e.g., elements, simple salts, and complex silicates) and also vary broadly in crystalline structure.

Minerals may be categorized as either bulk minerals, which are required in relatively large amounts, or trace minerals, which are required in relatively small amounts. Bulk minerals generally are required in amounts greater than or equal to about 100 mg per day and trace minerals are those that are required in amounts less than about 100 mg per day.

In some embodiments, the mineral is chosen from bulk minerals, trace minerals or combinations thereof. Non-limiting examples of bulk minerals include calcium, chlorine, magnesium, phosphorous, potassium, sodium, and sulfur. Non-limiting examples of trace minerals include chromium, cobalt, copper, fluorine, iron, manganese, molybdenum, selenium, zinc, and iodine. Although iodine generally is classified as a trace mineral, it is required in larger quantities than other trace minerals and often is categorized as a bulk mineral.

In some embodiments, the mineral is a trace mineral, believed to be necessary for human nutrition, non-limiting examples of which include bismuth, boron, lithium, nickel, rubidium, silicon, strontium, tellurium, tin, titanium, tungsten, and vanadium.

The minerals embodied herein may be in any form known to those of ordinary skill in the art. For example, in a particular embodiment the minerals may be in their ionic form, having either a positive or negative charge. In another particular embodiment, the minerals may be in their molecular form. For example, sulfur and phosphorous often are found naturally as sulfates, sulfides, and phosphates.

Probiotics comprise microorganisms that benefit health when consumed in an effective amount. Desirably, probiotics beneficially affect the human body's naturally-occurring gastrointestinal microflora and impart health benefits apart from nutrition. Probiotics may include, without limitation, bacteria, yeasts, and fungi. Examples of probiotics include, but are not limited to, bacteria of the genus Lactobacilli, Bifidobacteria, Streptococci, or combinations thereof, that confer beneficial effects to humans. In some embodiments, the at probiotic is selected from L. acidophilus, L. case, L. fermentum, L. saliva roes, L. brevis, L. leichmannii, L. plantarum, L. cellobiosus, L. reuteri, L. rhamnosus, L. GG, L. bulgaricus, L. thermophilus, B. angulatum, B. animalis, B. asteroides, B. bifidum, B. boum, B. breve, B. catenulatum, B. chocrinum, B. coryneforme, B. cuniculi, B. dentium, B. gallicum, B. gallinarum, B indicum, B. longum, B. magnum, B. merycicum, B. minimum, B. pseudocatenulatum, B. pseudolongum, B. psychraerophilum, B. pullorum, B. ruminantium, B. saeculare, B. scardovii, B. simiac, B. subtile, B. thermacidophilum, B. thermophilum, B. urinalis, B. sp., Streptococcus salivarus, and Streptococcus cremoris.

“Fatty acid” refers to any straight chain monocarboxylic acid and includes saturated fatty acids, unsaturated fatty acids, long chain fatty acids, medium chain fatty acids, short chain fatty acids, fatty acid precursors (including omega-9 fatty acid precursors), and esterified fatty acids. As used herein, “long chain polyunsaturated fatty acid” refers to any polyunsaturated carboxylic acid or organic acid with a long aliphatic tail. As used herein, “omega-3 fatty acid” refers to any polyunsaturated fatty acid having a first double bond as the third carbon-carbon bond from the terminal methyl end of its carbon chain. In particular embodiments, the omega-3 fatty acid may comprise a long chain omega-3 fatty acid. As used herein, “omega-6 fatty acid” any polyunsaturated fatty acid having a first double bond as the sixth carbon-carbon bond from the terminal methyl end of its carbon chain.

Suitable omega-3 fatty acids for use in embodiments of the present invention can be derived from algae, fish, animals, plants, or combinations thereof, for example. Examples of suitable omega-3 fatty acids include, but are not limited to, linolenic acid, alpha-linolenic acid, eicosapentaenoic acid, docosahexaenoic acid, stearidonic acid, eicosatetraenoic acid and combinations thereof. In some embodiments, suitable omega-3 fatty acids can be provided in fish oils, (e.g., menhaden oil, tuna oil, salmon oil, bonito oil, and cod oil), microalgae omega-3 oils or combinations thereof. In particular embodiments, suitable omega-3 fatty acids may be derived from commercially available omega-3 fatty acid oils such as Microalgae DHA oil (from Martek, Columbia, Md.), OmegaPure (from Omega Protein, Houston, Tex.), Marinol C-38 (from Lipid Nutrition, Channahon, Ill.), Bonito oil and MEG-3 (from Ocean Nutrition, Dartmouth, NS), Evogel (from Symrise, Holzminden, Germany), Marine Oil, from tuna or salmon (from Arista Wilton, CT), OmegaSource 2000, Marine Oil, from menhaden and Marine Oil, from cod (from OmegaSource, RTP, NC).

Suitable omega-6 fatty acids include, but are not limited to, linoleic acid, gamma-linolenic acid, dihommo-gamma-linolenic acid, arachidonic acid, eicosadienoic acid, docosadienoic acid, adrenic acid, docosapentaenoic acid and combinations thereof.

Suitable esterified fatty acids for embodiments of the present invention may include, but are not limited to, monoacylgycerols containing omega-3 and/or omega-6 fatty acids, diacylgycerols containing omega-3 and/or omega-6 fatty acids, or triacylgycerols containing omega-3 and/or omega-6 fatty acids and combinations thereof.

As used herein, the phrases “stanol”, “plant stanol” and “phytostanol” are synonymous.

Plant sterols and stanols are present naturally in small quantities in many fruits, vegetables, nuts, seeds, cereals, legumes, vegetable oils, bark of the trees and other plant sources. Although people normally consume plant sterols and stanols every day, the amounts consumed are insufficient to have significant cholesterol-lowering effects or other health benefits. Accordingly, it would be desirable to supplement food and beverages with plant sterols and stanols.

Sterols are a subgroup of steroids with a hydroxyl group at C-3. Generally, phytosterols have a double bond within the steroid nucleus, like cholesterol; however, phytosterols also may comprise a substituted sidechain (R) at C-24, such as an ethyl or methyl group, or an additional double bond. The structures of phytosterols are well known to those of skill in the art.

At least 44 naturally-occurring phytosterols have been discovered, and generally are derived from plants, such as corn, soy, wheat, and wood oils; however, they also may be produced synthetically to form compositions identical to those in nature or having properties similar to those of naturally-occurring phytosterols. According to particular embodiments of this invention, non-limiting examples of phytosterols well known to those or ordinary skill in the art include 4-desmethylsterols (e.g., β-sitosterol, campesterol, stigmasterol, brassicasterol, 22-dehydrobrassicasterol, and 45-avenasterol), 4-monomethyl sterols, and 4,4-dimethyl sterols (triterpene alcohols) (e.g., cycloartenol, 24-methylenecycloartanol, and cyclobranol).

As used herein, the phrases “stanol”, “plant stanol” and “phytostanol” are synonymous. Phytostanols are saturated sterol alcohols present in only trace amounts in nature and also may be synthetically produced, such as by hydrogenation of phytosterols. According to particular embodiments of this invention, non-limiting examples of phytostanols include β-sitostanol, campestanol, cycloartanol, and saturated forms of other triterpene alcohols.

Both phytosterols and phytostanols, as used herein, include the various isomers such as the a and β isomers (e.g., α-sitosterol and β-sitostanol, which comprise one of the most effective phytosterols and phytostanols, respectively, for lowering serum cholesterol in mammals).

The phytosterols and phytostanols of the present invention also may be in their ester form. Suitable methods for deriving the esters of phytosterols and phytostanols are well known to those of ordinary skill in the art, and are disclosed in U.S. Pat. Nos. 6,589,588, 6,635,774, 6,800,317, and U.S. Patent Publication Number 2003/0045473, the disclosures of which are incorporated herein by reference in their entirety. Non-limiting examples of suitable phytosterol and phytostanol esters include sitosterol acetate, sitosterol oleate, stigmasterol oleate, and their corresponding phytostanol esters. The phytosterols and phytostanols of the present invention also may include their derivatives.

### 4.2.4. Method of Preparing Soft Spread Composition

In one aspect, a method of preparing the soft spread composition is provided.

First, a dry mixture of the plant-based protein component described herein above is provided. “Dry” refers to ingredients that are not liquid or semi-solid, e.g., the oil and fat components described hereinabove. “Dry” does not mean that the substance is entirely without water, however, as the substance can have some atmospheric moisture.

In some embodiments, the dry mixture is mixed a blender or mixer typical of food processing equipment, e.g., ribbon blender.

The dry mixture is then fed into a cooker extruder along with water, and the mixture is plasticized and extruded at an elevated temperate to provide an extruded spread pre-mixture.

In some embodiments, water is fed into the cooker extruder in an amount of 10 wt % to about 50 wt % of the total feed (plant-based protein component and water), such as, for example, about 10 wt % to about 40 wt %, from about 10 wt % to about 30 wt %, from about 10 wt % to about 20 wt %, from about 20 wt % to about 50 wt %, from about 20 wt % to about 40 wt %, from about 20 wt % to about 30 wt %, from about 30 wt % to about 50 wt %, from about 30 wt % to about 40 wt %, or about 40 wt % to about 50 wt %.

In some embodiments, the extruded spread pre-mixture is dried. Any suitable dryer can be used to provide the desired moisture content. In some embodiments, the extruded spread pre-mixture is dried to provide a moisture content of from about 0.5% to about 5%, such as, for example, from about 1% to about 4%, or from about 2% to about 4%.

In some embodiments, the extruded spread pre-mixture is milled to provide the desired particle size. In some embodiments, the particle side distribution of the milled spread pre-mixture is from about 50 microns to about 800 microns, such as, for example, from about 50 microns to about 500 microns, from about 50 microns to about 400 microns, from about 50 microns to about 250 microns, from about 100 microns to about 800 microns, from about 100 microns to about 500 microns, from about 100 microns to about 250 microns, from about 200 microns to about 800 microns, from about 200 microns to about 500 microns, from about 200 microns to about 400 microns, from about 300 microns to about 800 microns, from about 300 microns to about 500 microns, from about 400 microns to about 800 microns, from about 400 microns to about 500 microns, and from about 400 microns to about 800 microns.

In some embodiments, after extrusion, drying, and milling, the extruded spread composition is combined with wet ingredients (e.g., the lipid component) and, optionally, one or more additives (e.g., colors and vitamins), to provide a wet spread mixture. The wet spread mixture is mixed under high shear (e.g., up to 2,200 rpm) until the resulting material is substantially homogenous and creamy, i.e., no dry material is observed, thereby providing the soft spread composition. High shear mixing equipment is known in the art and includes batch high shear mixers, in-line high shear mixers, and power induction high shear mixers.

In some embodiments, the lipid component comprises from about 30 wt % to about 50 wt % of the wet spread mixture, e.g., from about 30 wt % to about 45 wt %, from about 30 wt % to about 40 wt %, from about 30 wt % to about 35 wt %, from about 35 wt % to about 50 wt %, from about 35 wt % to about 45 wt %, from about 35 wt % to about 40 wt %, from about 40 wt % to about 50 wt %, from about 40 wt % to about 45 wt %, or from about 40 wt % to about 50 wt %. In some embodiments, the lipid component comprises from about 35 wt % to about 40 wt % of the wet spread mixture, e.g., from about 35 wt % to about 37 wt % or from about 37 wt % to about 40 wt %.

In some embodiments, the extruded soft spread composition is mixed sufficient to provide a soft spread composition viscosity greater than about 250,000 CPS at ambient temperature (e.g., 75 F), greater than about 300,000 CPS, or greater than 400,000. In some embodiments, the extruded soft spread composition is mixed sufficient to provide a soft spread composition viscosity from about 250,000 CPS to about 500,000 CPS at ambient temperature (e.g., 75 F), e.g., from 250,000 CPS to 450,000 CPS, from 250,000 CPS to 400,000 CPS, from 250,000 CPS to 350,000 CPS, from 250,000 CPS to 300,000 CPS, from 300,000 CPS to 500,000 CPS, from 300,000 CPS to 450,000 CPS, from 300,000 CPS to 400,000 CPS, from 300,000 CPS to 350,000 CPS, from 350,000 CPS to 500,000 CPS, from 350,000 CPS to 450,000 CPS, from 350,000 CPS to 400,000 CPS, from 400,000 CPS to 500,000 CPS, from 400,000 CPS to 450,000 CPS, or from 450,000 CPS to 500,000 CPS.

In some embodiments, the extruded spread is packaged in a container, e.g., a jar, bottle, pouch, sachet, etc.

### 4.3. High Protein Snack Compositions

In one aspect, high protein extruded snack compositions are provided. The high protein extruded snack composition is delicious and exhibits one or more desirable nutritional properties: low glycemic index, high protein quality, glycemic neutrality, low calorie content, excellent source of protein and fiber, low net carbs, low starch, and low fat.

The high protein extruded snack composition can be provided in any form, for example a chip, puff, flake, nugget, hollow tube, pillow, stick, sphere, collet, cone, cylinder, cube, cuboid, ellipsoid, and tetrahedron or other geometric shape.

In some embodiments, the high protein extruded snack is a hollow shell that resembles a hollow “pillow” shape. In such embodiments, the shape of the high protein extruded snack is essentially a hollow rectilinear cube. In some embodiments, the ends of the high protein extruded snack are sealed. In other embodiments, the ends of the high protein extruded snack composition are unsealed, i.e., the shape is a hollow rectilinear tube.

The dimensions of the high protein snack composition will vary depending on the shape extruded. In some embodiments, any dimension of the composition is less than about 35 mm, less than about 15 mm, or less than about 5 mm. In some embodiments, any dimension of the composition ranges from about 20 mm to about 55, from about 10 mm to about 20 mm, or from about 2 mm to about 10 mm.

In some embodiments, the largest dimension of the composition is less than about 35 mm, less than about 15 mm, or less than about 5 mm. In some embodiments, the largest dimension of the composition ranges from about 20 mm to about 55, from about 10 mm to about 20 mm, or from about 2 mm to about 10 mm.

In some embodiments, a pillow-shaped high protein snack composition has a length from about 20 mm to about 30 mm, a width from about 20 mm to about 30 mm, and a thickness of about 10 mm to about 20 mm.

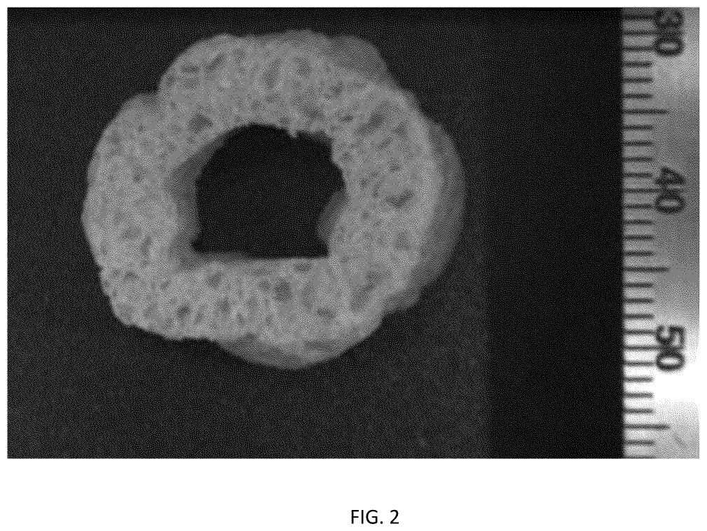

In some embodiments, the high protein snack is a hollow rectilinear cube or hollow pillow shape that has an inner diameter and outer diameter (e.g., FIG. 2). In some embodiments, the hollow rectilinear tube has a non-uniform inner diameter. In some embodiments, the hollow rectilinear tube has a non-uniform outer diameter. In some embodiments, the hollow rectilinear tube has both a non-uniform inner diameter and non-uniform outer diameter.

In some embodiments, the inner diameter of the hollow rectilinear cube or hollow pillow shape is from 1 mm to 10 mm, e.g., from 1 mm to 8 mm, from 1 mm to 5 mm, from 1 mm to 3 mm, from 3 mm to 10 mm, from 3 mm to 8 mm, from 3 mm to 5 mm, from 5 mm to 10 mm, from 5 mm to 8 mm, or from 8 mm to 10 mm.

In some embodiments, the outer diameter of the hollow rectilinear cube or hollow pillow shape is from 15 mm to 25 mm, e.g., from 15 mm to 20 mm, from 20 mm to 25 mm, or from 25 mm to 30 mm.

In some embodiments, the hollow rectilinear cube or hollow pillow shape has an inner diameter from 1 mm to 10 mm and an outer diameter from 15 mm to 25 mm. In some embodiments, the hollow rectilinear cube or hollow pillow shape has an inner diameter from 5 mm to 10 mm and an outer diameter from 15 mm to 20 mm.

The high protein snack compositions have a desirable light, crunchy, and crisp texture. Texture can be measured, for example, using texture analyzer by methods known in the art. The extruder process conditions enable nucleation (steam flashing) of the rubbery phase extrudate that creates a cell structure which, upon drying, provides the desired properties.

In some embodiments, the water content of the high protein snack composition is from about 2 wt % to about 6 wt %, such as, for example, from about 2 wt % to about 5 wt %, from about 3 wt % to about 6%, or from about 2 wt % to about 4 wt %.

In some embodiments, the high protein snack composition has a protein content of about 5 g to about 15 g per 1 oz (33 g) serving, such as, for example, from about 5 g to about 10 g, or about 10 g to about 15 g.

In some embodiments, the high protein snack composition has a fat content of about 0.5 g to about 5 g per 1 oz (28 g) serving, such as, for example, from about 0.5 g to about 1.5 g, from about 1 g to about 5 g, from about 1 g to about 3 g, or from about 2 g to about 5 g.

In some embodiments, the high protein snack composition has from about 50 calories to about 200 calories per 1 oz (28 g) serving, such as, for example, from about 50 to about 150 calories, from about 50 to about 100 calories, from about 100 to about 200 calories, from about 100 to about 150 calories, or from about 150 to about 200 calories.

In some embodiments, the high protein snack has a total starch content of about 5 g to about 15 g per 1 oz (28 g) serving, such as, for example, from about 5 g to about 10 g, or from about 10 g to about 15 g.

In some embodiments, the high protein snack composition has a total fiber content of about 3 g to about 10 g, such as, for example, from about 3 g to about 8 g, from about 3 g to about 5 g, or from about 5 g to about 10 g.

In some embodiments, the high protein snack composition has a stable shelf-life of at least about 6 months, at least about 7 months, at least about 8 months, at least about 9 months, at least about 10 months, at least about 11 months, or at least about 12 months. Shelf-life stability can be measured according to methods known in the art, e.g., HPLC, visual inspection, and chemical analysis over time. “Stable” refers to not more than 5% change (e.g., degradation or transformation) in a given ingredient and no visible change from the initial form of the composition (e.g., melting appearance/hydration or discoloration).

### 4.3.1. Plant-Based Protein

The high protein snack composition is primarily comprised of a plant-based protein component.

In some embodiments, the plant-based protein component comprises at least one pulse protein source. Exemplary pulse sources are described hereinabove.

In some embodiments, the plant-based protein component consists of pulse protein sources. In some embodiments, the plant-based protein component comprises from about 20 wt % to about 100 wt % at least one pulse protein, such as, for example, from about 20 wt % to about 75 wt %, from about 20 wt % to about 50 wt %, from about 50 wt % to about 100 wt %, from about 50 wt % to about 75 wt %, from about 75 wt % to about 100 wt %. In some embodiments, the plant-based protein component comprises from about 60 wt % to about 85 wt % at least one pulse protein source, such as, for example, from about 60 wt % to about 80 wt %, from about 60 wt % to about 70 wt %, from about 70 wt % to about 85 wt %, from about 70 wt % to about 80 wt %, from about 75 wt % to about 85 wt %, or from about 80 wt % to about 85 wt %.

In some embodiments, the plant-based protein component further comprises at least one rice protein source. Exemplary rice protein sources are described hereinabove. In some embodiments, the plant-based protein component comprises from about 1 wt % to about 40 wt % at least one rice protein source, such as, for example, from about 10 wt % to about 40 wt %, from about 10 wt % to about 30 wt %, from about 10 wt % to about 20 wt %, from about 20 wt % to about 40 wt %, from about 20 wt % to about 30 wt %, from about 30 wt % to about 40 wt %. In some embodiments, the plant-based protein component comprises from about 15 wt % to about 25 wt %, from about 15 wt % to about 20 wt %, from about 20 wt % to about 30 wt %, from about 20 wt % to about 25 wt %, or about 25 wt % to about 30 wt % at least one rice protein source.

In some embodiments, the plant-based protein component comprises at least one pulse protein source and at least one rice protein source. In some embodiments, the plant-based protein component comprises two pulse protein sources and two rice protein sources. In some embodiments, the pulse protein sources comprise pulse flour, pulse protein isolate, or a combination thereof. In some embodiments, the rice protein sources comprise rice protein, rice meal, or a combination thereof. In exemplary embodiments, the plant-based protein component comprises yellow pea flour, pea protein isolate, brown rice protein, and brown rice meal.

In some embodiments, the high protein snack composition comprises at least about 60 wt % plant-based protein component, such as, for example, at least about 65 wt %, at least about 70 wt %, at least about 75 wt %, at least about 80 wt %, at least about 85 wt %, or at least about 90 wt %. In some embodiments, the high protein snack composition comprises from about 60 wt % to about 90 wt % plant-based protein component, such as, for example, from about 60 wt % to about 80 wt %, from about 60 wt % to about 70 wt %, from about 70 wt % to about 90 wt %, from about 70 wt % to about 80 wt %, or from about 80 wt % to about 90 wt %.

### 4.3.2. Additives

In some embodiments, the high protein snack composition comprises one or more additives described hereinabove.

In some embodiments, the high protein snack comprises at least one mineral additive for fortification. Any mineral described hereinabove can be used. In some embodiments, the mineral is calcium, e.g., provided in the form of calcium carbonate.

In some embodiments, the high protein snack comprises from about 0.01 wt % to about 5 wt % at least one additive, such as, for example, from about 0.5 wt % to about 5 wt % or from about 1 wt % to about 5 wt %.

### 4.3.3. Topical Seasoning

In some embodiments, the high protein snack composition is coated with a topical seasoning comprising at least one oil and at least one dry seasoning. It has been found that coating the high protein snack with the topical seasoning is organoleptically preferred to embedding the seasoning within the high protein snack composition and provides both flavor vibrancy and salivation.

In some embodiments, the high protein snack composition comprises from about 3 wt % to about 10 wt % topical seasoning, such as, for example, from about 3 wt % to about 10 wt %, from about 3 wt % to about 8 wt %, from about 3 wt % to about 5 wt %, or from about 5 wt % to about 10 wt %.

In some embodiments, the at least one oil is a vegetable oil. Suitable oils include, but are not limited to, rapeseed oil, corn oil, soybean oil, sunflower seed oil, cotton seed oil, maize oil, olive oil, hazelnut oil, groundnut oil, and liquid fractions of palm oil or of shea butter. This includes varieties of these liquid oils, such as for instance, but not limited to, high oleic sunflower oil and high oleic rapeseed oil. In some embodiments, the oil comprises high oleic sunflower oil.

Seasonings include, but are not limited to, minerals (such as salts), grain-based seasonings (such as, but not limited to, whole, cracked or ground wheat, corn, oats, rye, flax, barley, spelt and rice), plant-derived seasonings (such as, but not limited to, onion, garlic, pepper, capsicum pepper, herbs, spices, nuts, olives, fruits, vegetables, etc.), and other flavorings (such as, but not limited to, vanilla, sugar, cheese, yeast extract, whey), and combinations thereof.

In some embodiments, the seasoning is sweet. In some embodiments, the seasoning is savory. In still other embodiments, the at least one seasoning comprises both sweet and savory seasonings.

In some embodiments, the topical seasoning comprises a salt composition comprising sodium chloride and potassium chloride, wherein the amount of sodium chloride is less than the amount of potassium chloride. In some embodiments, the salt composition comprises at least 25% less sodium chloride than potassium chloride, e.g., at least 35% less sodium chloride than potassium chloride, or at least 50% less sodium chloride than potassium chloride. In some embodiments, the salt composition comprises from 25% to 75% less sodium chloride than potassium chloride, e.g., from 25% to 50% less sodium chloride than potassium chloride, from 25% to 35% less sodium chloride than potassium chloride, or from 35% to 50% less sodium chloride than potassium chloride. Without wishing to be bound by theory, it is believed that use of the salt composition functions as a taste enhancer, enabling a positive organoleptic response atypical of conventional sodium levels.

In some embodiments, topical seasoning does not contain salt. In other embodiments, the topical seasoning contains low salt, i.e., the at least one dry seasoning mixture comprises less than 3 wt % salt, such as, for example, less than about 2 wt %, less than about 1 wt %, from about 0.01 wt % to about 3 wt %, from about 0.01 wt % to about 2 wt %, from about 0.01 wt % to about 1 wt %, or from about 0.01 wt % to about 0.5 wt %.

### 4.3.4. Method of Preparing High Protein Snack Compositions

In one aspect, a method of preparing an plurality of extruded high protein snack compositions is provided comprising (i) providing a dry mixture comprising the plant-based protein component and optionally, one or more additives, (ii) mixing the dry mixture with water to form a dough, (iii) cooker extruding the dough to provide a continuous extrudate; (iv) cutting the continuous extrudate to form a plurality of high protein snack compositions; and (v) drying the plurality of high protein snack compositions.

In some embodiments, the dry mixture and water are combined in a mixer or blender sufficient to provide a dough consistency suitable for extrusion. In some embodiments, water is present in the dough in an amount of about 10 wt % to about 40 wt %, such as, for example, from about 10 wt % to about 30 wt %, or from about 10 wt % to about 20 wt %.

In some embodiments, the dough is fed into a cooker extruder. The extrusion process is described hereinabove. The extrudate emerging from the extruder barrel typically has a moisture content of less than about 40% (by weight extrudate), such as, for example, from about 5% to about 40%. Upon release of pressure, the dough exits the extruder barrel through the die, superheated water present in the mass flashes off as steam, causing simultaneous expansion (i.e., puffing) of the material.

The extrudate is a continuous shape, e.g., a hollow tube, that may be cut after exiting the die to provide a plurality of high protein snack compositions. Suitable apparatus for cutting the extrudate include flexible knives manufactured by Wenger (Sabetha, Kans.) and Clextral (Tampa, Fla.). Various die orifice designs will cause different expansions and geometric shapes of the extrudate. For example, depending on the geometric shape of the extrudate, the sliced or cut extrudate may be in the shape of a sheet, disc, pellet, rod, string, bar, pillow, crunchy curl, puffs, chip, crisp, cracker, wafer, flaked product, etc.

In some embodiments, a rotary crimper is used to form a pillow-shaped extruded high protein snack composition.

In some embodiments, the plurality of extruded high protein snack compositions are dried. Any suitable drying equipment known in the art can be used, e.g., a single-pass dryer. In some embodiments, the final moisture content is from about 2% to about 30%, such as, for example, from about 2% to about 10%, from about 2% to about 5%, from about 2% to about 4%, or from about 3% to about 5%.

In some embodiments, the plurality of high protein snack compositions is further coated with the topical seasoning. In some embodiments, the plurality of high protein snack composition, at least one oil, and at least one dry seasoning and are combined in a coating drum until sufficient coating is achieved.

In some embodiments, a plurality of high protein snack compositions is packaged and sealed. In one embodiment, a plurality of high protein snack compositions is packaged into a bag by vertical form-fill seal bagging. In some embodiments, one or more servings of the plurality of high protein snack compositions are packaged, e.g., from about 1 oz (28 g) to about 50 oz, such as, for example, from about 1 oz to about 25 oz, from about 1 oz to about 15 oz, from about 1 oz to about 10 oz, or from about 1 oz to about 6 oz.

### 4.4. Dual-Texture High Protein Extruded Compositions

In one aspect, dual-texture high protein compositions are provided that contain the soft spread composition (also referred to as “filling”) described hereinabove and the crunchy high protein snack composition described hereinabove in direct contact. In some embodiments, as described in more detail hereinbelow, the soft spread composition and high protein snack composition are co-extruded. These high protein, high fiber coextruded products provide superior organoleptic properties and excellent nutritional benefits. The dual-texture high protein extruded composition exhibits one or more desirable nutritional properties: low glycemic index, high protein quality, glycemic neutrality, low calorie content, excellent source of protein and fiber, low net carbs, low starch, low fat, low sodium, and a source of minerals (e.g., calcium) and vitamins.

In some embodiments, the soft spread composition is a first layer in direct contact with a second layer that is the high protein snack composition (also referred to as the “crunchy shell composition” or “shell composition”). In some embodiments, the soft spread composition described hereinabove is a filling inside the void of a crunchy shell composition.

In some embodiments, a dual-texture high protein extruded composition comprises:
(i) a soft spread composition comprising a plant-based protein component, a lipid component, and optionally one or more additives; and
(ii) a crunchy shell composition in direct contact with the soft spread composition, wherein the crunchy shell composition comprises a plant-based protein component and optionally one or more additives.

In some embodiments, a dual-texture high protein extruded composition comprises:
(i) a soft spread composition comprising a plant-based protein component, a lipid component, and optionally one or more additives; and
(ii) a crunchy shell composition in direct contact with and partially surrounding the soft spread composition, wherein the crunchy shell composition comprises a plant-based protein component and optionally one or more additives.

In some embodiments, a dual-texture high protein extruded composition comprises:
(i) a soft spread composition comprising a plant-based protein component, a lipid component, and optionally one or more additives; and
(ii) a crunchy shell composition in direct contact with and completely surrounding the soft spread composition, wherein the crunchy shell composition comprises a plant-based protein component and optionally one or more additives.

In some embodiments, the dual-texture high protein extruded composition is in the form of a filled cracker, chip, puff, flake, nugget, tube, pillow, sphere, collet, cone, cylinder, cube, cuboid, ellipsoid, tetrahedron, or other geometric shape. In some embodiments, the dual-texture high protein extruded composition is a filled puff. In some embodiments, the dual-texture high protein extruded composition is a filled chip.

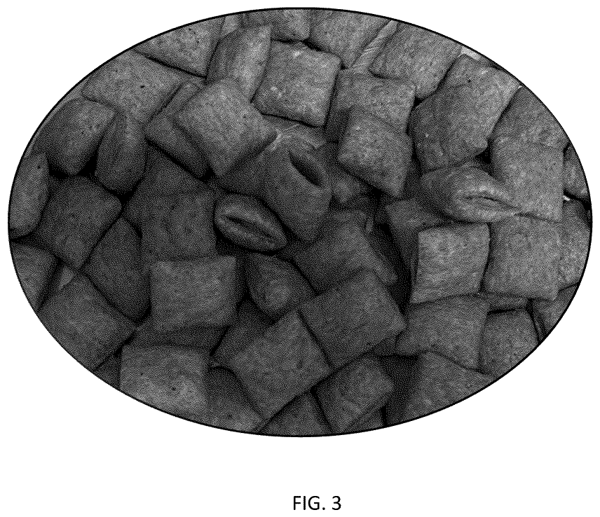

In some embodiments, the dual-texture high protein extruded composition is a filled pillow (e.g., FIG. 3). In such embodiments, the outer shape of the dual-texture high protein extruded composition is essentially a rectilinear cube. In some embodiments, the ends of the composition are sealed, i.e., the inner soft spread composition/filling is completely surrounded by the outer shell composition.

In other embodiments, one or both ends of the dual-texture high protein extruded composition are unsealed (partially surrounded), e.g., the shape is a rectilinear filled tube. The crunchy shell composition appears to have a generally tubular shape which surrounds the inner soft spread composition on all sides except the ends of the generally tubular shape. As such, the soft spread composition is exposed on the ends of the tubular shaped outer crispy shell composition. The cross-section of the tube may be any geometric shape including circular, triangular, square, or any other shape that may be envisioned by those skilled in the art.

The dimensions of the dual-texture high protein extruded composition will vary depending on the shape extruded. In some embodiments, the any dimension of the composition is less than about 35 mm, less than about 15 mm, or less than about 5 mm. In some embodiments, any dimension of the composition ranges from about 20 mm to about 55, from about 10 mm to about 20 mm, or from about 2 mm to about 10 mm.

In some embodiments, the largest dimension of the composition is less than about 35 mm, less than about 15 mm, or less than about 5 mm. In some embodiments, the largest dimension of the composition ranges from about 20 mm to about 55, from about 10 mm to about 20 mm, or from about 2 mm to about 10 mm.

In some embodiments, a dual-texture high protein pillow-shaped composition has a length from about 20 mm to about 30, a width from about 20 mm to about 30 mm, and a thickness of about 10 mm to about 20 mm.

In some embodiments, the dual-texture high protein extruded composition is a filled rectilinear cube or filled pillow shape that has an outer diameter from 15 mm to 25 mm, e.g., from 15 mm to 20 mm, from 20 mm to 25 mm, or from 25 mm to 30 mm.

In some embodiments, the weight of the dual-texture high protein extruded composition is from about 1.5 g to about 10 g, such as, for example, 1.5 g to about 5 g. 1.5 g to about 3 g. 3 g to about 10 g, 3 g to about 5 g, or about 5 g to about 10 g.

The outer crunchy shell portion and inner softer spread portion hardness may be determined by using an instrument such as a Texture Analyzer to insert a conical-ended ⅛ inch diameter rod into the respective portions of the product at a prescribed velocity of 0.3 mm/sec. The hardness of the respective components can be related to the maximum force encountered during the process of inserting the rod through each portion. By this, or a similar, method the hardness of the harder outer shell portion is at least about 75 times greater than the hardness of the softer inner spread filling, preferably at least about 95 times greater.

In some embodiments, the dual-texture high protein extruded composition comprises from about 25 wt % to about 50 wt % soft spread composition and from about 50 wt % to about 75 wt % crunchy shell composition. In some embodiments, the dual-texture high protein extruded composition comprises from about 30 wt % to about 50 wt % soft spread composition and from about 50 wt % to about 70 wt % crunchy shell composition. In some embodiments, the dual-texture high protein extruded composition comprises from about 40 wt % to about 50 wt % soft spread composition and from about 50 wt % to about 60 wt % crunchy shell composition. In some embodiments, the dual-texture high protein extruded composition comprises from about 25 wt % to about 40 wt % soft spread composition and from about 60 wt % to about 75 wt % crunchy shell composition. In some embodiments, the dual-texture high protein extruded composition comprises from about 25 wt % to about 30 wt % soft spread composition and from about 70 wt % to about 75 wt % crunchy shell composition.

In some embodiments, the weight ratio of the soft spread composition to the crunchy shell composition in the dual-texture high protein extruded composition is from about 1:1.5 to about 1:4, such, as, for example, from about 1:1.5 to about 1:3, from about 1.15 to about 1:2, from about 1:2 to about 1:4, from about 1:2 to about 1:3, or from about 1:3 to about 1.4.

In some embodiments, the dual-texture high protein extruded composition comprises a topical seasoning described hereinabove. That is, the dual-texture high protein extruded composition is coated with the topical seasoning comprising at least one oil and at least one dry seasoning.

In some embodiments, the topical seasoning comprises from about 3 wt % to about 10 wt % of the dual-texture high protein extruded composition, such as, for example, from about 3 wt % to about 10 wt %, from about 3 wt % to about 8 wt %, from about 3 wt % to about 5 wt %, or from about 5 wt % to about 10 wt %. In some embodiments, the soft spread composition and the outer shell composition comprise from about 90 wt % to about 97 wt % of the total dual-texture high protein extruded composition, such as, for example, from about 90 wt % to about 95 wt % or from about 95 wt % to about 97 wt %.

In some embodiments, a plurality of dual-texture high protein extruded compositions is packaged into a 1 oz or 28 g serving. In some embodiments, single or multiple servings are packaged together, e.g., in a sealed container such as a bag. In some embodiments, two or more 1 oz dual-texture high protein extruded composition servings are combined, such as, for example, three or more servings, four or more servings, five or more servings, or six or more servings.

The dual-texture high protein extruded compositions benefit consumers by providing a low glycemic index and/or glycemic load while delivering a good source of protein, fiber, micronutrients, reduced fat and sodium with unanticipated indulgent consumer desirability.

In some embodiments, the dual-texture high protein extruded composition has a glycemic index less than about 55, such as, for example, less than about 50, less than about 45, less than about 40, less than about 35, less than about 30, or less than about 25.

In some embodiments, the dual-texture high protein extruded composition has a glycemic load of about 10 or less, e.g., less than about 9, less than about 8, less than about 7, less than about 6, or less than about 5.

In some embodiments, the dual-texture high protein extruded composition has a protein quality equivalent to an egg as defined by protein digestibility corrected amino acid score (PDCAAS). An egg has a PDCAAS score of 1. The dual-texture high protein extruded composition has a PDCAAS score of at least about 0.7, such as, for example, at least about 0.8, at least about 0.9, from about 0.7 to about 1.0, from about 0.8 to about 1.0, or from about 0.9 to about 1.0. In some embodiments, the dual-texture high protein extruded composition has a PDCAAS score from 0.5 to 1.0, e.g., from 0.5 to 0.8, from 0.6 to 0.9, or from 0.7 to 0.8. In some embodiments, the dual-texture high protein extruded composition has a PDCAAS score from 0.7 to 0.8.

In some embodiments, the dual-texture high protein extruded composition has at least about 8 g of protein per 1 oz (28 g) serving, e.g., about 8 g, about 9 g, about 10 g, about 11 g, or about 12 g. In some embodiments, the dual-texture high protein extruded composition has at least about 10 g of protein per 1 oz (28 g) serving.

In some embodiments, the dual-texture high protein extruded composition has from about 3 g to about 10 g of fiber per 1 oz serving (28 g), such as, for example, from about 3 g to about 8 g, from about 3 g to about 5 g, from about 5 g to about 10 g, from about 5 g to about 8 g, or from about 8 g to about 10 g. In some embodiments, the dual-texture high protein extruded composition has about 4 g of fiber per serving. In some embodiments, the dual-texture high protein extruded composition has a fat content from about 3 g to about 10 g per 1 oz serving, such as, for example, from about 3 g to about 8 g, from about 3 g to about 5 g, from about 5 g to about 10 g, from about 5 g to about 8 g, or from about 8 g to about 10 g.

In some embodiments, the dual-texture high protein extruded composition does not contain trans fats. In other embodiments, the dual-texture high protein extruded composition contains from 0.1 to about 3 g of trans fats.

In some embodiments, the dual-texture high protein extruded composition has less than about 2 g of saturated fat per 1 oz (28 g) serving, e.g., less than about 1.5 g or less than about 1.0 g.

In some embodiments, the soft spread composition has less than about 200 mg sodium per serving (33 g), e.g., less than about 150 mg, less than about 100 mg, less than about 50 mg, or less than about 20 mg. In some embodiments, the dual-texture high protein extruded composition has from about 100 to about 150 calories per 1 oz serving (28 g) serving, such as, for example, from about 100 to about 140 calories, from about 100 to about 130 calories, from about 100 to about 120 calories, from about 100 to about 110 calories, from about 110 to about 150 calories, from about 110 to about 140 calories, from about 110 to about 130 calories, from about 110 to about 120 calories, from about 120 to about 150 calories, from about 120 to about 140 calories, from about 120 to about 130 calories, from about 130 to about 150 calories, from about 130 to about 140 calories, or from about 140 to about 150 calories.

In some embodiments, the dual-texture high protein extruded composition has less than about 9 net carbohydrate content per 1 oz (28 g) serving. In some embodiments, the dual-texture high protein extruded composition has a net carbohydrate content from about 1 g to about 10 g per 1 oz (28 g) serving, such as, for example, from about 1 g to about 7 g, from about 1 g to about 5 g, from about 1 g to about 3 g, from about 3 g to about 10 g, from about 3 g to about 7 g, from about 3 g to about 5 g, from about 5 g to about 10 g, from about 5 g to about 7 g, or from about 7 g to about 10 g.

In some embodiments, the dual-texture high protein extruded composition is characterized by one or more of the following per 1 oz (28 g serving): less than about 9 g carbohydrate content, at least about 8 g of protein, and at least about 3 g of fiber. In some embodiments, the dual-texture high protein extruded composition has two or more of the following per 1 oz (28 g serving): less than about 9 g net carbohydrate content, at least about 8 g of protein, and at least about 3 g of fiber. In some embodiments, the dual-texture high protein extruded composition has less than about 9 g net carbohydrate content, at least about 8 g of protein, and at least about 3 g of fiber.

In some embodiments, the dual-texture high protein extruded composition does not contain added sugars. In other embodiments, the dual-texture high protein extruded composition contains from about 0.5 g to about 3 g added sugars.

In some embodiments, fat provides 35% or less of the total calorie content in the dual-texture high protein extruded composition per 1 oz (28 g) serving, e.g., about 30% or less, about 25% or less, about 20% or less, about 15% or less, about 10% or less, or about 5% or less.

In some embodiments, saturated fat provides about 10% or less of the total calorie content in the dual-texture high protein extruded composition per 1 oz (28 g) serving, e.g., about 8% or less, about 5% or less, or about 3% or less.

In some embodiments, the dual-texture high protein extruded composition comprises about 200 mg or less of sodium per 1 oz (28 g) serving, e.g., about 150 mg or less, about 100 mg or less, or about 50 mg or less.

In some embodiments, the dual-texture high protein extruded composition is characterized by one or more of the following per 1 oz (28 g serving): about 35% or less of the total calorie content provided by fat, about 10% or less of the total calorie content from saturated fat, about 200 calories or less, and about 200 mg or less sodium.

In some embodiments, the dual-texture high protein extruded composition has a stable shelf-life of at least about 6 months, at least about 7 months, at least about 8 months, at least about 9 months, at least about 10 months, at least about 11 months, or at least about 12 months. Shelf-life stability can be measured according to methods known in the art, e.g., HPLC visual inspection, and chemical analysis over time. “Stable” refers to not more than 5% change (e.g., degradation or transformation) in a given ingredient and no visible change from the initial form of the composition (e.g., melting appearance/hydration, solidification or liquifying spread, or discoloration).

### 4.4.1. Method of Preparing Dual-Texture High Protein Extruded Composition

In one aspect, methods of preparing the dual-texture high protein extruded compositions are provided. The present method provides efficient co-extrusion processes for preparing stuffed compositions with high protein content in both the outer layer (shell) and inner layer (filling).

In some embodiments, a method of preparing a plurality of dual-texture high protein extruded compositions comprises:
a. preparing a soft spread composition comprising:
   i. cooker extruding a dry mixture comprising a first plant-protein component comprising at least one pulse protein source and water to provide an extruded spread pre-mixture;
   ii. drying the extruded spread pre-mixture to provide a dried spread pre-mixture:
   iii. milling the dried spread pre-mixture;
   iv. combining the milled, dried spread pre-mixture with a lipid component comprising at least one fat and at least one oil and optionally one or more additives to provide a wet spread mixture, and
   v. subjecting the wet spread mixture to high shear mixing until the resulting material is substantially homogenous and creamy, thereby providing the soft spread composition:
b. preparing a shell dough composition comprising:
   i. mixing a second plant-based protein component comprising at least one pulse protein source, water, and optionally one or more additives to form a dough:
c. co-extruding the shell dough composition into a continuous hollow tube shape and pumping the soft spread composition into the void of the tube shape to provide a crispy, continuous filled tube;
d. crimping the continuous filled tube to provide a plurality of dual-texture high protein extruded compositions;
e. drying the plurality of dual-texture high protein extruded compositions;
f. optionally, coating the dual-texture high protein extruded compositions with a topical seasoning comprising at least one oil and at least one dry seasoning.

Step (a) is carried out as described hereinabove for the soft spread composition. Step (b) is carried out as described hereinabove for the high protein snack composition.

With respect to step (c), co-extruding means that the outer crispy shell material is continuously manufactured by a cooking or forming extruder and the inner soft spread composition is continuously combined with the outer crispy shell material by means of a co-extrusion die. The co-extrusion die combines the flows of each material resulting in a continuous flow stream of the combined outer and inner materials.

In some embodiments, the soft spread composition is pumped into the hollow tube shape is from about 25% to about 40% by weight of the total feed (soft spread composition and shell dough composition),

The viscosity of the spread should be sufficient for pumping into the shell. In some embodiments, the viscosity of the spread composition is at least about 10,000 CPS, such as, for example, at least about 100,000 CPS.

The co-extrudate is a continuous shape, e.g., a filled tube that may be cut after exiting the die to provide a plurality of dual-texture high protein extruded compositions. Suitable apparatus for cutting the extrudate include flexible knives manufactured by Wenger (Sabetha, Kans.) and Clextral (Tampa, Fla.). Various die orifice designs will cause different expansions and geometric shapes of the co-extrudate. For example, depending on the geometric shape of the extrudate, the sliced or cut filled extrudate may be in the shape of a cracker, chip, puff, flake, nugget, hollow tube, pillow, stick, sphere, collet, cone, cylinder, cube, cuboid, ellipsoid, or tetrahedron.

In some embodiments, a rotary crimper is used to form a plurality of pillow-shaped dual-texture high protein extruded compositions.

In some embodiments, the plurality of dual-texture high protein extruded compositions is dried. Any suitable drying equipment known in the art can be used, e.g., a single-pass dryer. In some embodiments, the final moisture content is from about 0.5% to about 5%, such as, for example, from about 1% to about 4% or about 2% to about 4%.

In some embodiments, the plurality of high protein snack compositions is further coated with the topical seasoning. In some embodiments, the plurality of high protein snack compositions, at least one oil, and at least one dry seasoning and are combined in a coating drum until sufficient coating is achieved.

In some embodiments, a plurality of high protein snack compositions is packaged. In one embodiment, a plurality of high protein snack compositions is packaged into a bag by vertical form-fill seal bagging. In some embodiments, one or more servings of the plurality of high protein snack compositions are packaged, e.g., from about 1 oz (28 g) to about 50 oz, such as, for example, from about 1 oz to about 25 oz, from about 1 oz to about 15 oz, from about 1 oz to about 10 oz, or from about 1 oz to about 6 oz.

### 5. EXAMPLES

### 5.1. Example 1

### 5.1.1. Preparation of Dual-Texture High Protein Extruded Compositions

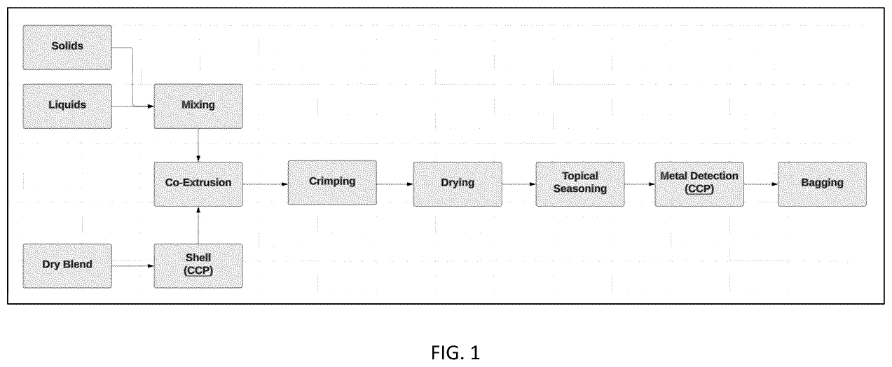

A block diagram depicting the process for preparing the dual-texture high protein extruded compositions described herein is provided in FIG. 1 and explained in more detail below.

Filling Mass Base Extrusion (1)—Low starch, high protein and fiber rich materials were mixed in the following proportions using a double helix ribbon blender:

| Extrudate Dry Blend | Amount (wt %) |
|---|---|
| Pulse Flour | 35-45 |
| Rice Protein | 1-15 |
| Pulse Protein Isolate | 20-40 |
| Pulse Fiber Source | 10-20 |
| Mix: Extrudate Dry Blend | 100.000 |

This dry blend material was fed into a cooker extruder using a loss-in-weight feeder at a rate of 500 to 1,500 kg/hour with the addition of 60 to 650 kg/hour (10-30%) ambient potable water. A specific mechanical energy input of >20 watt-hours/kg was imparted into the dough as it is plasticized and eventually discharged from the extruder >90° C. The material was subsequently dried >230° F. for >15 minutes to 2.0% to 6.0% moisture to a bulk density of 150-400 grams/liter.

Extrudate Milling (2)—The extrudate was subsequently milled to a particle size distribution (PSD)<1,000 μm.

Filling High Shear Mixing (3)—Natural dry and liquid flavors and colors were added to the milled extrudate with lipids and additives at the ratios below and mixed in a variable shear mixer to a temperature of <150° F. enabling a pumpable viscosity of <500,000 CPS.

| Soft spread composition Ingredients | Amount (wt %) |
|---|---|
| Plant Based Protein Flour | 40-50 |
| Soft Fat | 20-30 |
| Oil | 10-20 |
| Emulsifier | 1-5 |
| Vitamin mix | 0.1-1 |
| Flavors and Colors | 10-20 |
| Soft spread composition | 100.000 |

Shell Dry Blend (4)—Low starch containing dry materials and micronutrient blend listed below were mixed using a single helix paddle hybrid mixer with the addition of 10-40% water creating a dough:

| Shell Dry Blend | Amount (wt %) |
|---|---|
| Pulse Flour | 60-80 |
| Rice Protein | 5-10 |
| Rice Meal | 10-20 |
| Pulse Protein Isolate | 5-10 |
| Additives | 0.1-5 |
| Mix: Shell Dry Blend | 100.000 |

Shell Extrusion (5)—The low starch shell dough matrix was subsequently fed through a loss-in-weight feeder into a cooker-extruder at a rate of 500-1,500 kg/hour. Mechanical and thermal energy was imparted sufficient to plasticize the substrate <165° C. This is an important step to enable microbial stabilization.

Co-Extrusion (6)—In embodiments used for preparing the dual-texture snack, steps (5) and (6) are performed together, i.e., coextrusion. The filling mass was pumped into the void filled by the shell annulus at a rate of 170-1,000 kg/hour (25% to total) in the following ratios:

| Co-Extrusion | Amount (wt %) |
|---|---|
| Shell Extrusion & Drying | 60-70 |
| Center Soft spread composition | 30-40 |
| Mix: Co-Extrusion | 100.000 |

Crimping (7)—The coextrudate was passed through a rotary crimper forming a flange to encapsulate the filling phase.

Drying (8)—The coextruded base was passed through a gas-fired dryer for <60 minutes at <350° F. enabling a crispy, crunchy texture with a moisture <6%.

Topical Seasoning (9)—Oil and dry seasoning powder were topically applied to the co-extruded base at the following proportions through a rotating tumble drum to provide a plurality of dual-texture high protein extruded compositions:

| | Amount |
|---|---|
| Topical Seasoning | (weight %) |
| Co-Extrusion | 92.348 |
| Oil | 5.000 |
| Dry seasoning mix | 2.652 |
| Mix: Topical Seasoning | 100.000 |

The dual-texture high protein extruded composition had the appearance as shown in FIG. 3.

Packaging (10)—Following in-line metal detection to ensure food safety, the finished goods were packed in pillow packs with a modified atmosphere of less than 5% residual oxygen and case packaged.

### 5.1.2. Nutritional Information for Dual-Texture High Protein Extruded Compositions

Craveable taste and texture characteristic of globally branded snack foods are typically unhealthy, high carbohydrate products (starchy, cereal grain based) packed with sodium, flavor potentiators, MSG, allergens and other undesirable constituents with low and poor quality protein (PDCAAS <0.35), low fiber and high net carbohydrates (>15) with a high glycemic index (>75). The dual-texture high protein extruded compositions of the present disclosure benefit consumers by providing a legume-based (pulse) snack food product that has a low glycemic index and glycemic load while delivering a good source of protein, fiber, micronutrients, reduced fat and sodium with unanticipated indulgent consumer desirability.

The ingredient and nutritional information for an exemplary serving of the dual-texture high protein extruded composition is provided below.

Exemplary ingredient listing: yellow pea flour, sunflower oil, pea protein isolate, brown rice, brown rice protein, palm fat, pea fiber, natural flavors, tapioca starch, turmeric oil (color), sunflower lecithin, yeast extract, citric acid, sea salt, lactic acid, onion powder, garlic powder, paprika extract (color), paprika oleoresin (color), spices.

### Nutritional Information for Exemplary Ingredient Listing (Per 1 Oz or 28 g Serving)

| | | |
|---|---|---|
| Nutritional Measure | Amount | % Daily Value |

| Calories | 130 | | — |
|---|---|---|---|
| Total Fat | 5 | g | 6% |
| Saturated Fat | 1.4 | | 7% |
| Trans Fat | 0 | g | — |
| Cholesterol | 0 | mg | 0% |
| Sodium | 140 | mg | 6% |
| Total Carbohydrates | 13 | g | 5% |
| Dietary Fiber | 4 | g | 14% |
| Total Sugars | 0 | g | — |
| Added Sugars | 0 | g | 0% |
| Protein | 8 | g | 12% |
| Vitamin D | 2.4 | mcg | 10% |
| Calcium | 60 | mg | 4% |
| Iron | 1.7 | mg | 10% |
| Vitamin A | 110 | mcg | 10% |
| Vitamin C | 11 | mg | 10% |
| Vitamin B6 | 0.21 | mg | 10% |
| Vitamin B12 | 0.29 | mcg | 10% |
| Zinc | 1.1 | mg | 10% |

### 6. EQUIVALENTS AND INCORPORATION BY REFERENCE

While the invention has been particularly shown and described with reference to a preferred embodiment and various alternate embodiments, it will be understood by persons skilled in the relevant art that various changes in form and details can be made therein without departing from the spirit and scope of the invention.

All references, issued patents and patent applications cited within the body of the instant specification are hereby incorporated by reference in their entirety, for all purposes.

What is claimed is:

1. A dual-texture high protein extruded composition comprising:
a. a soft spread composition comprising a first plant-based protein component and a lipid component, wherein the first plant-based protein component comprises at least one pulse protein source and the lipid component comprises at least one fat and at least one oil; and
b. a crunchy shell composition in direct contact with the soft spread composition, wherein the crunchy shell composition comprises a second plant-based protein component comprising at least one pulse protein source.

2. The dual-texture high protein extruded composition of claim 1, wherein the crunchy shell composition surrounds the soft spread composition.

3. The dual-texture high protein extruded composition of claim 1 or 2, wherein the soft spread composition comprises from about 50 wt % to about 80 wt % of the first plant-based protein component.

4. The dual-texture high protein extruded composition any one of claims 1-3, wherein the pulse protein source in (a) is in the form of a concentrate, an isolate, a hydrolysate, a flour, or a meal.

5. The dual-texture high protein extruded composition of any one of claims 1-4, wherein in (a), the pulse is selected from pea, pinto bean, navy bean, black bean, and lentil.

6. The dual-texture high protein extruded composition of any one of claims 1-5, wherein in (a), the plant-based protein component comprises from about 20 wt % to about 80 wt % at least one pulse flour.

7. The dual-texture high protein extruded composition of any one of claims 1-6, wherein in (a), the plant-based protein component comprises from about 75 wt % to about 100 wt % at least one pulse protein.

8. The dual-texture high protein extruded composition of any one of claims 1-7, wherein in (a), the pulse protein source comprises yellow pea flour and pea protein isolate.

9. The dual-texture high protein extruded composition any one of claims 1-8, wherein the first plant-based protein component further comprises at least one rice protein source in the form of a protein, a flour, or a meal.

10. The dual-texture high protein extruded composition of claim 9, wherein the first plant-based protein component comprises from about from about 10 wt % to about 40 wt % at least one rice protein source.

11. The dual-texture high protein extruded composition of claim 9 or 10, wherein the rice is selected from brown rice, white rice, wild rice, black rice, and red rice.

12. The dual-texture high protein extruded composition of any one of claims 9-11, wherein the rice is brown rice.

13. The dual-texture high protein extruded composition of any one of claims 1-12, wherein the first plant-based protein component further comprises at least one fiber source.

14. The dual-texture high protein extruded composition of claim 13, wherein the first plant-based protein component comprises from about 60 wt % to about 99 wt % at least one protein source and from about 1% to about 40% of at least one fiber source.

15. The dual-texture high protein extruded composition of claim 14, wherein the at least one fiber source is a pulse source.

16. The dual-texture high protein extruded composition of claim 15, wherein the pulse is selected from pea, pinto bean, navy bean, black bean, and lentil.

17. The dual-texture high protein extruded composition of any one of claims 13-16, wherein the fiber source is pea fiber.

18. The dual-texture high protein extruded composition of any one of claims 1-17, wherein in (a), the fat is selected from fully or partially hydrogenated oil(s), solid stearin fractions, partial esters such as diglycerides and monoglycerides, waxes, and combinations thereof.

19. The dual-texture high protein extruded composition of any of claims 1-18, wherein (a) comprises from about 15 wt % to about 30 wt % of at least one fat.

20. The dual-texture high protein extruded composition of any one of claims 1-19, wherein in (a), the oil is selected from rapeseed oil, corn oil, soybean oil, sunflower seed oil, cotton seed oil, maize oil, olive oil, hazelnut oil, groundnut oil, liquid fractions of palm oil or of shea butter, and combinations thereof.

21. The dual-texture high protein extruded composition of any one of claims 1-20, wherein (a) comprises from about 5 wt % to about 20 wt % at least one oil.

22. The dual-texture high protein extruded composition of any one of claims 1-21, wherein (a) comprises from about 20 wt % to about 50 wt % lipid component.

23. The dual-texture high protein extruded composition of any one of claims 1-22, wherein (a) comprises from about 30 wt % to about 40 wt % lipid component.

24. The dual-texture high protein extruded composition of any one of claims 1-23, wherein (a) further comprises one or more additives selected from stabilizers, flavoring agents, emulsifiers, anti-spattering agents, colorants, preservatives, antioxidants, vitamins, minerals, probiotics, probiotics, phytosterols and phytostanols.

25. The dual-texture high protein extruded composition of any one of claims 1-24, wherein the water activity (aw) of (a) is about 0.30 or less.

26. The dual-texture high protein extruded composition of any one of claims 1-25, wherein the water activity is about 0.30 or less.

27. The dual-texture high protein extruded composition of any one of claims 1-27, wherein (a) has a hardness (T) maximum of 1000 g.

28. The dual-texture high protein extruded composition of any one of claims 1-28, wherein (a) has a viscosity from about 250,000 to 500,00 CPS at ambient temperature.

29. The dual-texture high protein extruded composition of any one of claims 1-28, wherein in (b), the second plant-based protein component comprises from about 20 wt % to about 100 wt % at least one pulse protein source.

30. The dual-texture high protein extruded composition of any one of claims 1-29, wherein (b) comprises from about 50 wt % to about 70 wt % at least one pulse protein source.

31. The dual-texture high protein extruded composition of any one of claims 1-30, wherein in (b), the plant-based protein component comprises from about 1 wt % to about 40 wt % at least one rice protein source.

32. The dual-texture high protein extruded composition of any one of claims 1-31, wherein (b) comprises at least about 60 wt % plant-based protein component.

33. The dual-texture high protein extruded composition of any one of claims 1-32, wherein in (b), the pulse protein source is in the form of a concentrate, an isolate, a hydrolysate, a flour, or a meal.

34. The dual-texture high protein extruded composition of any one of claims 1-33, wherein in (b), the pulse is selected from pea, pinto bean, navy bean, black bean, and lentil.

35. The dual-texture high protein extruded composition of any one of claims 1-34, wherein in (b), the at least one pulse source comprises yellow pea flour and pea protein isolate.

36. The dual-texture high protein extruded composition of any one of claims 1-35, wherein the second plant-protein component further comprises at least one rice protein source.

37. The dual-texture high protein extruded composition of claim 36, wherein the at least one rice protein source is in the form of a protein, a flour, or a meal.

38. The dual-texture high protein extruded composition of claim 36 or 37, wherein the rice is selected from brown rice, white rice, wild rice, black rice, and red rice.

39. The dual-texture high protein extruded composition of any one of claims 1-38, wherein the at last one rice source comprises brown rice protein and brown rice meal.

40. The dual-texture high protein extruded composition of any one of claims 1-39, wherein the dual-texture high protein extruded composition is in the form of a filled cracker, filled chip, filled puff, filled nugget, filled tube, filled pillow, filled sphere, filled collet, filled cone, filled cylinder, filled cube, filled cuboid, filled ellipsoid, and filled tetrahedron.

41. The dual-texture high protein extruded composition of any one of claims 1-40, wherein the dual-texture high protein extruded composition is in the form of a filled pillow.

42. The dual-texture high protein extruded composition of any one of claims 1-41, wherein the dimensions of the filled pillow are from about 20 mm to about 30 long, from about 20 mm to about 30 mm wide, and about 10 mm to about 20 mm thick.

43. The dual-texture high protein extruded composition of any one of claims 1-42, wherein (b) is at least about 75 times greater the hardness of (a).

44. The dual-texture high protein extruded composition of any one of claims 1-43, wherein the dual-texture high protein extruded composition comprises from about 25 wt % to about 50 wt % (a) and from about 50 wt % to about 75 wt % (b).

45. The dual-texture high protein extruded composition of any one of claims 1-44, wherein the weight ratio of (a) to (b) is from about 1:1.5 to about 1:4.

46. The dual-texture high protein extruded composition of any one of claims 1-45, further comprising topical seasoning comprising at least one oil and at least one dry seasoning.

47. The dual-texture high protein extruded composition of claim 46, wherein the at least one oil comprises rapeseed oil, corn oil, soybean oil, sunflower seed oil, cotton seed oil, maize oil, olive oil, hazelnut oil, groundnut oil, liquid fractions of palm oil or of shea butter, or combinations thereof.

48. The dual-texture high protein extruded composition of claims 46 and 47, wherein the at least one dry seasoning comprises minerals (e.g., salts), grain-based seasonings (e.g., whole, cracked or ground wheat, corn, oats, rye, flax, barley, spelt and rice), plant-derived seasonings (e.g., onion, garlic, pepper, capsicum pepper, herbs, spices, nuts, olives, fruits, vegetables, etc.), flavorings (e.g., vanilla, sugar, cheese, yeast extract, whey), or combinations thereof.

49. The dual-texture high protein extruded composition of claims 46-48, wherein the at least one dry seasoning comprises a salt composition comprising sodium chloride and potassium chloride, wherein the amount of sodium chloride is less than the amount of potassium chloride.

50. The dual-texture high protein extruded composition of any one of claims 1-49 characterized by at least one of the following per 1 oz (28 g) serving: (i) a glycemic index of about 55 or less, (ii) a glycemic load of about 10 or less, (iii) a PDCAAS score from about 0.5 to about 1.0, (iv) from about 100 to about 150 calories, (v) a fat content from about 3 g to about 10 g, (vi) a net carbohydrate content of less than about 9 g, (vii) at least about 3 g of fiber, (viii) less than about 2 g of saturated fat, (ix) less than about 200 mg sodium, (x) 35% or less of the total calorie content provided by fat, and (xi) 10% or less of the total calorie content provided by saturated fat.

51. A method of making a plurality of dual-texture high protein extruded compositions comprising:
a. preparing a soft spread composition comprising:
i. cooker extruding a dry mixture comprising a first plant-protein component comprising at least one pulse protein source and water to provide an extruded spread pre-mixture;
ii. drying the extruded spread pre-mixture to provide a dried spread pre-mixture:
iii. milling the dried spread pre-mixture;
iv. combining the milled, dried spread pre-mixture with a lipid component comprising at least one hard fat and at least one oil and optionally one or more additives to provide a wet spread mixture, and
v. subjecting the wet spread mixture to high shear mixing until the resulting material is substantially homogenous and creamy, thereby providing the soft spread composition;
b. preparing a shell dough composition comprising:
i. mixing a dry mixture comprising a second plant-based protein component comprising at least one pulse protein source, water, and optionally one or more additives to form a dough:
c. co-extruding the shell dough composition into a continuous hollow tube shape and pumping the soft spread composition into the void of the tube shape to provide a crispy, continuously filled tube;
d. crimping the continuous filled tube to provide a plurality of dual-texture high protein extruded compositions; and
e. drying the plurality of dual-texture high protein extruded compositions.

52. The method of claim 51, wherein before step (a), the dry mixture is blended or mixed.

53. The method of claim 51 or 52, wherein in (a), the dry mixture and water are fed into the cooker extruder separately.

54. The method of any one of claims 51-53, wherein in (a), the water is fed into the cooker extruder in an amount from about 10 wt % to about 50 wt % of the total feed.

55. The method of any one of claims 51-54, wherein in (a), the extruded pre-spread mixture is dried to a moisture content of about 0.5% to about 5%.

56. The method of any one of claims 51-55, wherein in (a), the dried spread pre-mixture is milled to provide a particle size distribution from about 50 microns to about 800 microns.

57. The method of any one of claims 51-56, wherein in (a), the wet spread mixture is subjected to high shear until a viscosity of about 10,000 CPS to about 500,000 CPS is achieved.

58. The method of any one of claims 51-57, wherein in (a), the pulse protein source is in the form of a concentrate, an isolate, a hydrolysate, a flour, or a meal.

59. The method of any one of claims 51-58, wherein in (a), the pulse is selected from pea, pinto bean, navy bean, black bean, and lentil.

60. The method of any one of claims 51-59, wherein in (a), the plant-based protein component comprises from about 20 wt % to about 80 wt % at least one pulse flour.

61. The method of any one of claims 51-60, wherein in (a), the plant-based protein component comprises from about 75 wt % to about 100 wt % at least one pulse protein.

62. The method of any one of claims 51-61, wherein in (a), the at least one pulse source comprises yellow pea flour and pea protein isolate.

63. The method of any one of claims 51-62, wherein the first plant-based protein component further comprises at least one rice protein source in the form of a protein, a flour, or a meal.

64. The method of claim 63, wherein in the first plant-based protein component comprises from about from about 1 wt % to about 40 wt % at least one rice protein source.

65. The method of claim 64, wherein the rice is selected from brown rice, white rice protein, wild rice, black rice, and red rice.

66. The method of any one of claims 63-65, wherein the rice is brown rice.

67. The method of any one of claims 51-66, wherein the first plant-based protein component further comprises at least one fiber source.

68. The method of claim 67, wherein the first plant-based protein component comprises from about 60 wt % to about 99 wt % at least one protein source and from about 1 wt % to about 40 wt % at least one fiber source.

69. The method of claim 67 or 68, wherein the at least one fiber source is a pulse source.

70. The method of any one of claims 67-69, wherein the pulse is selected from pea, pinto bean, navy bean, black bean, and lentil.

71. The method of any one of claims 67-70, wherein the fiber source is pea fiber.

72. The method of any one of claims 51-71, wherein in (a), the fat is selected from fully or partially hydrogenated oil(s), solid stearin fractions, partial esters such as diglycerides and monoglycerides, waxes, and combinations thereof.

73. The method of any of claims 51-72, wherein the soft spread composition comprises from about 15 wt % to about 30 wt % at least one fat.

74. The method of any one of claims 51-73, wherein in (a), the oil is selected from rapeseed oil, corn oil, soybean oil, sunflower seed oil, cotton seed oil, maize oil, olive oil, hazelnut oil, groundnut oil, liquid fractions of palm oil or of shea butter, and combinations thereof.

75. The method of any one of claims 51-74, wherein in (a), the soft spread composition comprises from about 5 wt % to about 20 wt % at least one oil.

76. The method of any one of claims 51-75, wherein in (a), the soft spread composition comprises from about 20 wt % to about 50 wt % lipid component.

77. The method of any one of claims 51-76, wherein in (a), the soft spread composition comprises from about 35 wt % to about 40 wt % lipid component.

78. The method of any one of claims 51-77, wherein in (a), the one or more additives are selected from stabilizers, flavoring agents, emulsifiers, anti-spattering agents, colorants, preservatives, antioxidants, vitamins, minerals, probiotics, fatty acids, phytosterols and phytostanols.

79. The method of any one of claims 51-78, wherein in (b), water is present in the dough in an amount from about 10 wt % to about 40 wt %.

80. The method of any one of claims 51-79, wherein in (b), the second plant-based protein component comprises from about 60 wt % to about 100 wt % at least one pulse protein source.

81. The method of any one of claims 51-80, wherein in (b), the pulse protein source is in the form of a concentrate, an isolate, a hydrolysate, a flour, or a meal.

82. The method of any one of claims 51-81, wherein in (b), the pulse is selected from pea, pinto bean, navy bean, black bean, and lentil.

83. The method of any one of claims 51-82, wherein in (b), the at least one pulse source comprises yellow pea flour and pea protein isolate.

84. The method of any one of claims 51-83, wherein in (b), the second plant-based protein component further comprises at least one rice protein source is the form of a protein, a flour, or a meal.

85. The method of claim 84, wherein the rice is selected from brown rice, white rice, wild rice, black rice, and red rice.

86. The method of claim 84 or 85, wherein the at least one rice source comprises brown rice protein and brown rice meal.

87. The method of any one of claims 51-86, wherein in (d), a rotary crimper is used to form a plurality of pillow shaped dual-texture high protein extruded compositions.

88. The method of any one of claims 51-87, wherein in (e), the plurality of pillow shaped dual-texture high protein extruded compositions is dried to a final moisture content of about 0.5% to about 5%.

89. The method of any one of claims 51-88, further comprising (f) combining the plurality of dual-texture high protein extruded compositions with a topical seasoning comprising at least one oil and at least one dry seasoning to coat the plurality of dual-texture high protein extruded compositions.

90. The method of claim 89, wherein the at least one oil comprises rapeseed oil, corn oil, soybean oil, sunflower seed oil, cotton seed oil, maize oil, olive oil, hazelnut oil, groundnut oil, liquid fractions of palm oil or of shea butter, or combinations thereof.

91. The method of claim 89 or 90, wherein the at least one dry seasoning comprises minerals (e.g., salts), grain-based seasonings (e.g., whole, cracked or ground wheat, corn, oats, rye, flax, barley, spelt and rice), plant-derived seasonings (e.g., onion, garlic, pepper, capsicum pepper, herbs, spices, nuts, olives, fruits, vegetables, etc.), flavorings (e.g., vanilla, sugar, cheese, yeast extract, whey), or combinations thereof.

92. The method of any one of claims 89-91, wherein the at least one dry seasoning comprises a salt composition comprising sodium chloride and potassium chloride, wherein the amount of sodium chloride is less than the amount of potassium chloride.

93. The method of any one of claims 51-89, further comprising packaging at least a fraction of the plurality of dual-texture high protein extruded compositions, e.g., combining from about 1 oz to about 50 oz of the plurality of dual-texture high protein extruded compositions and sealing them within a bag.

94. A soft spread composition comprising a plant-based protein component and a lipid component, wherein:
the plant-based protein component comprises at least one pulse protein source, and
the lipid component comprises at least one fat and at least one oil.

95. The soft spread composition of claim 94, wherein the soft spread composition comprises from about 50 wt % to about 80 wt % plant-based protein component.

96. The soft spread composition of claim 94 or 95, wherein the pulse protein source is in the form of a concentrate, an isolate, a hydrolysate, a flour, or a meal.

97. The soft spread composition of any one of claims 94-96, wherein the pulse is selected from pea, pinto bean, navy bean, black bean, and lentil.

98. The soft spread composition of any one of claims 94-97, wherein the plant-based protein component comprises from about 20 wt % to about 80% at least one pulse flour.

99. The soft spread composition of any one of claims 94-98, wherein the plant-based protein component comprises from about 75 wt % to about 100 wt % at least one pulse protein source.

100. The soft spread composition of any one of claims 94-99, wherein the at least one pulse protein source comprises yellow pea flour and pea protein isolate.

101. The soft spread composition any one of claims 94-100, wherein the plant-based protein component further comprises at least one rice protein source in the form of a protein, a flour, or a meal.

102. The soft spread composition of claim 101, wherein the plant-based protein component comprises from about from about 1 wt % to about 40 wt % at least one rice protein source.

103. The soft spread composition of claim 102, wherein the rice is selected from brown rice, white rice, wild rice, black rice, and red rice.

104. The soft spread composition of claim 102 or 103, wherein the rice is brown rice.

105. The soft spread composition of any one of claims 94-104, wherein the plant-based protein component further comprises at least one fiber source.

106. The soft spread composition of claim 105, wherein the plant-based protein component comprises from about 60 wt % to about 99 wt % at least one protein source and from about 1% to about 40% at least one fiber source.

107. The soft spread composition of claim 106, wherein the at least one fiber source is a pulse source.

108. The soft spread composition of any one of claims 105-107, wherein the pulse is selected from pea, pinto bean, navy bean, black bean, and lentil.

109. The spread composition of any one of claims 105-108, wherein the fiber source is pea fiber.

110. The soft spread composition of any one of claims 94-109, wherein the fat is selected from fully or partially hydrogenated oil(s), solid stearin fractions, partial esters such as diglycerides and monoglycerides, waxes, and combinations thereof.

111. The soft spread composition of any of claims 94-110, wherein the soft spread composition comprises from about 15 wt % to about 30 wt % at least one fat.

112. The soft spread composition of any one of claims 94-111, wherein the oil is selected from rapeseed oil, corn oil, soybean oil, sunflower seed oil, cotton seed oil, maize oil, olive oil, hazelnut oil, groundnut oil, liquid fractions of palm oil or of shea butter, and combinations thereof.

113. The soft spread composition of any one of claims 94-112, wherein the soft spread composition comprises from about 5 wt % to about 20 wt % at least one oil.

114. The soft spread composition of any one of claims 94-113, wherein the soft spread composition comprises from about 20 wt % to about 50 wt % lipid component.

115. The soft spread composition of any one of claims 94-114, wherein the soft spread composition comprises from about 30 wt % to about 40 wt % lipid component.

116. The soft spread composition of any one of claims 94-115, further comprising one or more additives selected from stabilizers, flavoring agents, emulsifiers, anti-spattering agents, colorants, preservatives, antioxidants, vitamins, minerals, and probiotics.

117. The soft spread compositions of any one of claims 94-116, wherein the water activity (aw) is about 0.30 or less.

118. The soft spread compositions of any one of claims 94-117, wherein the soft spread composition has a shelf-life of at least about 12 months.

119. The soft spread composition of any one of claims 94-118, wherein the soft spread composition has a hardness (T) maximum of 1000 g.

120. The soft spread composition of any one of claims 94-119, wherein the soft spread has a viscosity from about 250,000 to 500,00 CPS at ambient temperature.

121. The spread composition of any one of claims 94-120, wherein the soft spread composition has, per 1 oz (33 g) serving, or more of the following: from about 5 g to about 15 g protein, from about 5 g to about 15 g fat, from about 3 g to about 10 g fiber, and from about 150 to about 250 calories.

122. The soft spread composition of any one of claims 94-121, wherein the soft spread composition has a glycemic index less than 55.

123. The soft spread composition of any one of claims 94-122, wherein the soft spread composition is packaged in a container.

124. The soft spread composition of claim 123, wherein the container is selected from a single-use or resealable glass container, a single-use or resealable plastic container, a single-use pouch, and a resealable pouch.

125. A method of preparing a soft spread composition comprising:
a. cooker extruding a dry mixture of a plant-based protein component comprising at least one pulse protein source and water to provide an extruded spread pre-mixture,
b. drying the extruded spread pre-mixture to provide a dried spread pre-mixture,
c. milling the dried spread pre-mixture,
d. combining the milled, dried spread pre-mixture with a lipid component comprising at least one fat and at least one oil and one or more additives to provide a wet spread mixture; and
e. subjecting the wet spread mixture to high shear mixing until the resulting material is substantially homogenous and creamy, thereby providing a soft spread composition.

126. The method of claim 125, wherein before step (a), the dry mixture is blended or mixed.

127. The method of claim 125 or 126, wherein the dry mixture and water are fed into the cooker extruder separately.

128. The method of any one of claims 125-127, wherein the water is fed into the cooker extruder in an amount from about 10 wt % to about 50 wt % of the total feed.

129. The method of any one of claims 125-128, wherein the extruded pre-spread mixture is dried to a moisture content of 0.5% to about 5%.

130. The method of any one of claims 125-129, wherein dried spread pre-mixture is milled to provide a particle size distribution from about 50 microns to about 800 microns.

131. The method of any one of claims 125-130, wherein the wet spread mixture is subjected to high shear until a viscosity from about 10,000 CPS to about 500,000 CPS is achieved.

132. The method of any one of claims 125-131, wherein the soft spread composition comprises from about 50 wt % to about 80 wt % plant-based protein component.

133. The method of any one of claims 125-132, wherein the pulse protein source is in the form of a concentrate, an isolate, a hydrolysate, a flour, or a meal.

134. The method of any one of claims 125-133, wherein the pulse is selected from pea, pinto bean, navy bean, black bean, and lentil.

135. The method of any one of claims 125-134, wherein the plant-based protein component comprises from about 20 wt % to about 80% at least one pulse flour.

136. The method of any one of claims 125-135, wherein the plant-based protein component comprises from about 75 wt % to about 100 wt % at least one pulse protein source.

137. The method of any one of claims 125-136, wherein the at least one pulse source comprises yellow pea flour and pea protein isolate.

138. The method of any one of claims 125-137, wherein the plant-based protein component further comprises at least one rice protein source in the form of a protein, a flour, or a meal.

139. The method of claim 138, wherein the plant-based protein component comprises from about from about 10 wt % to about 40 wt % at least one rice protein source.

140. The method of any one of claim 138 or 139, wherein the rice is selected from brown rice, white rice protein, wild rice, black rice, and red rice.

141. The method of any one of claims 138-140, wherein the rice is brown rice.

142. The method of any one of claims 125-141, wherein the plant-based protein component further comprises at least one fiber.

143. The method of claim 142, wherein the plant-based protein component comprises from about 75 wt % to about 99 wt % at least one protein source and from about 1% to about 40% at least one fiber source.

144. The method of claim 142 or 143, wherein the at least one fiber source is also a pulse source.

145. The method of any one of claims 142-144, wherein the pulse is selected from pea, pinto bean, navy bean, black bean, and lentil.

146. The method of any one of claims 142-145, wherein the fiber source is pea fiber.

147. The method of any one of claims 125-146, wherein the fat is selected from fully or partially hydrogenated oil(s), solid stearin fractions, partial esters such as diglycerides and monoglycerides, waxes, and combinations thereof.

148. The method of any of claims 125-147, wherein the soft spread composition comprises from about 15 wt % to about 30 wt % at least one fat.

149. The method of any one of claims 125-148, wherein the oil is selected from rapeseed oil, corn oil, soybean oil, sunflower seed oil, cotton seed oil, maize oil, olive oil, hazelnut oil, groundnut oil, liquid fractions of palm oil or of shea butter, and combinations thereof.

150. The method of any one of claims 125-149, wherein the soft spread composition comprises from about 5 wt % to about 20 wt % at least one oil.

151. The method of any one of claims 125-150, wherein the soft spread composition comprises from about 20 wt % to about 50 wt % lipid component.

152. The method of any one of claims 125-151, wherein the soft spread composition comprises from about 30 wt % to about 40 wt % lipid component.

153. The method of any one of claims 125-152, wherein the one or more additives are selected from stabilizers, flavoring agents, emulsifiers, anti-spattering agents, colorants, preservatives, antioxidants, vitamins, minerals, probiotics, fatty acids, phytosterols, and phytostanols.

154. An extruded high protein snack composition comprising a plant-based protein component comprising at least one pulse protein source.

155. The extruded high protein snack composition of claim 154, wherein the plant-based protein component comprises from about 20 wt % to about 100 wt % at least one pulse protein source.

156. The extruded high protein snack composition of claim 154 or 155, wherein the high protein snack composition comprises from about 50 wt % to about 70 wt % at least one pulse protein source.

157. The extruded high protein snack composition of any one of claims 154-156, wherein the high protein snack composition comprises at least about 60 wt % plant-based protein component.

158. The extruded high protein snack composition of any one of claims 154-157, wherein the at least one pulse protein source is in the form of a concentrate, an isolate, a hydrolysate, a flour, or a meal.

159. The extruded high protein snack composition of any one of claims 154-158, wherein the pulse is selected from pea, pinto bean, navy bean, black bean, and lentil.

160. The extruded high protein snack composition of any one of claims 154-159, wherein the at least one pulse protein source comprises yellow pea flour and pea protein isolate.

161. The extruded high protein snack composition of any one of claims 154-160, further comprising at least one rice protein source.

162. The extruded high protein snack composition of claim 161, wherein the at least one rice protein source is in the form of a protein, a flour, or a meal.

163. The extruded high protein snack composition of claim 161 or 162, wherein the high protein snack composition comprises from about 10 wt % to about 20 wt % at least one rice protein source.

164. The extruded high protein snack composition of any one of claims 161-163, wherein the rice is selected from brown rice, white rice, wild rice, black rice, and red rice.

165. The extruded high protein snack composition of any one of claims 161-164, wherein the at least one rice protein source comprises brown rice protein and brown rice meal.

166. The extruded high protein snack composition of any one of claims 154-165, wherein the composition is in a form selected from a cracker, chip, puff, flake, nugget, hollow tube, hollow pillow, stick, sphere, collet, cone, cylinder, cube, cuboid, ellipsoid, and tetrahedron, preferably a hollow pillow.

167. The extruded high protein snack composition of any one of claims 154-166, wherein the dimensions of the composition are from about 20 mm to about 30 mm long, from about 20 mm to about 30 mm wide, and about 10 mm to about 20 mm thick.

168. The extruded high protein snack composition of any one of claims 154-167, wherein the composition has a water content of about 2% to about 30%.

169. The extruded high protein snack composition of any one of claims 154-168, wherein the composition has, per 1 oz (28 g) serving, or more of the following: from about 5 g to about 15 g protein, from about 0.5 g to about 5 g fat, and from about 50 to about 250 calories.

170. The extruded high protein snack composition of any one of claims 154-169, wherein the starch content of a 1 oz (28 g) serving is from about 5 g to about 15 g.

171. The extruded high protein snack composition of any one of claims 154-170, wherein the glycemic index is less than about 55.

172. The extruded high protein snack composition of any one of claims 154-171, further comprising a topical seasoning comprising at least one oil and at least one dry seasoning.

173. The extruded high protein snack composition of claim 172, wherein the at least one oil is selected from rapeseed oil, corn oil, soybean oil, sunflower seed oil, cotton seed oil, maize oil, olive oil, hazelnut oil, groundnut oil, liquid fractions of palm oil or of shea butter, and combinations thereof.

174. The extruded high protein snack composition of claim 172 or 173, wherein the at least one dry seasoning comprises minerals (e.g., salts), grain-based seasonings (e.g., whole, cracked or ground wheat, corn, oats, rye, flax, barley, spelt and rice), plant-derived seasonings (e.g., onion, garlic, pepper, capsicum pepper, herbs, spices, nuts, olives, fruits, vegetables, etc.), flavorings (e.g., vanilla, sugar, cheese, yeast extract, whey), or combinations thereof.

175. The extruded high protein snack composition of any one of claims 172-174, wherein the at least one dry seasoning comprises a salt composition comprising sodium chloride and potassium chloride, wherein the amount of sodium chloride is less than the amount of potassium chloride.

176. A method of preparing a plurality of high protein snack compositions comprising:
a. mixing a dry mixture of a plant-based protein component comprising at least one pulse protein source and water to form a dough;
b. cooker extruding the dough to provide a continuous extrudate;
c. cutting the continuous extrudate to form a plurality of high protein snack compositions; and
d. drying the plurality of high protein snack compositions.

177. The method of claim 176, wherein water is present in the dough in an amount from about 10 wt % to about 40 wt %.

178. The method of claim 176 or 177, wherein the continuous extrudate is in the form of a hollow tube.

179. The method of any one of claims 176-178, wherein a rotary crimper is used to cut the continuous extrudate to form a plurality of hollow pillow shaped high protein snack compositions.

180. The method of any one of claims 176-179, wherein the plurality of pillow shaped high protein snack compositions is dried to a moisture content from about 2% to about 30%.

181. The method of any one of claims 176-180, further comprising coating the plurality of high protein snack compositions with a topical seasoning comprising at least one oil and at least one dry seasoning.

182. The method of claim 181, wherein the at least one oil is selected from rapeseed oil, corn oil, soybean oil, sunflower seed oil, cotton seed oil, maize oil, olive oil, hazelnut oil, groundnut oil, liquid fractions of palm oil or of shea butter, and combinations thereof.

183. The method of claim 181 or 182, wherein the at least one dry seasoning comprises minerals (e.g., salts), grain-based seasonings (e.g., whole, cracked or ground wheat, corn, oats, rye, flax, barley, spelt and rice), plant-derived seasonings (e.g., onion, garlic, pepper, capsicum pepper, herbs, spices, nuts, olives, fruits, vegetables, etc.), flavorings (e.g., vanilla, sugar, cheese, yeast extract, whey), or combinations thereof.

184. The method of any one of claims 181-183, wherein the at least one dry seasoning comprises a salt composition comprising sodium chloride and potassium chloride, wherein the amount of sodium chloride is less than the amount of potassium chloride.

185. The method of any one of claims 176-181, further comprising packaging at least a fraction of the plurality of high protein snack compositions, e.g., combining from about 1 oz to about 50 oz of the plurality of high protein snack compositions and sealing within a bag.

186. The method of any one of claims 176-185, wherein the plant-based protein component comprises from about 20 wt % to about 100 wt % at least one pulse protein source.

187. The method of any one of claims 176-186, wherein the pulse protein source is in the form of a concentrate, an isolate, a hydrolysate, a flour, or a meal.

188. The method of any one of claims 176-187, wherein the pulse is selected from pea, pinto bean, navy bean, black bean, and lentil.

189. The method of any one of claims 176-188, wherein the at least one pulse source comprises yellow pea flour and pea protein isolate.

190. The method of any one of claims 176-189, further comprising at least one rice protein.

191. The method of claim 190, wherein the at least one rice protein source is in the form of a protein, a flour, or a meal.

192. The method of claim 190 or 191, wherein the rice is selected from brown rice, white rice, wild rice, black rice, and red rice.

193. The method of any one of claims 190-192, wherein the at least one rice source comprises brown rice protein and brown rice meal.

194. The method of any one of claims 176-193, wherein the plant-based protein component further comprises one or more additives.

195. A dual-texture high protein extruded composition comprising (a) the soft spread composition of any one of claims 94-124 and (b) the extruded high protein snack composition of any one of claims 154-175, wherein (a) is the inner layer, (b) is the outer layer, and (a) and (b) are in direct contact.
